(19) United States
(12) Patent Application Publication
(10) Pub. No.: US 2023/0003608 A1
(43) Pub. Date: Jan. 5, 2023

(54) Derivation Method, Derivation Device, Derivation System, And Program

(71) Applicant: SEIKO EPSON CORPORATION, Tokyo (JP)

(72) Inventor: Yoshihiro KOBAYASHI, Komagane (JP)

(21) Appl. No.: 17/852,508

(22) Filed: Jun. 29, 2022

(30) Foreign Application Priority Data
Jun. 30, 2021 (JP) 2021-108746

(51) Int. Cl. G01M 5/00

(52) U.S. Cl. CPC G01M 5/0008; G01M 5/0041; G01M 5/0033

(57) ABSTRACT

A first index value, which is an index value of a deflection amount of a structure generated at an observation point, and a second index value, which is an index value of a deflection amount at a designated position in the structure, are acquired based on the number of moving objects formed in a formation moving object, an entry time point, an exit time point, and environment information. An estimated value of the deflection amount of the structure at the designated position is derived based on time-series data measured at the observation point, the first index value, and the second index value.

The present application is based on, and claims priority from JP Application Serial Number 2021-108746, filed Jun. 30, 2021, the disclosure of which is hereby incorporated by reference herein in its entirety.

### BACKGROUND

### 1. Technical Field

The present disclosure relates to a derivation method, a derivation device, a derivation system, and a program.

### 2. Related Art

In recent years, many social infrastructures have deteriorated over time, and there is a demand for a method for diagnosing a state of a structure constituting a social infrastructure such as a railway bridge.

JP-B-6543863 discloses a method for investigating structural performance of a railway bridge, which makes it possible to appropriately investigate and evaluate structural performance of a bridge by using observation data of acceleration response of the bridge during traveling of a train. In the method for investigating structural performance of a railway bridge according to JP-B-6543863, a theoretical analysis model of dynamic response of a railway bridge during traveling of a train is formulated using a train as a moving load train and a bridge as a simple beam, acceleration of the bridge during traveling of the railway train is measured, and unknown parameters of the theoretical analysis model are estimated from this acceleration data by a reverse analysis method.

JP-B-6467304 discloses a method for obtaining an impact coefficient (dynamic response component) of a bridge by using a vehicle vertical acceleration response of a traveling train particularly when the traveling train passes through the bridge.

There is a case where a formation moving object formed with one or more moving objects, such as a railway train, moves on a structure such as a bridge. In such a case, for a purpose of diagnosis of the structure or the like, there is a demand to obtain a deflection amount at a designated position in the structure. When the deflection amount is measured using a sensor or the like at an observation point on the structure, the deflection amount cannot be obtained at a position other than the observation point. Also in JP-B-6543863 and JP-B-6467304, the deflection amount at a position different from the observation position cannot be obtained.

### SUMMARY

A derivation method includes: an acquisition step of acquiring time-series data including a physical quantity generated at a predetermined observation point in a structure as a response caused by a movement of a formation moving object formed with one or more moving objects on the structure; an environment information acquisition step of acquiring, as environment information, information on a structure length that is a length of the structure, a moving object length that is a length of the moving object, and an installation position of a contact portion of the moving object with the structure; a time point derivation step of deriving an entry time point and an exit time point of the formation moving object with respect to the structure based on the time-series data; a number acquisition step of acquiring the number of the moving objects formed in the formation moving object; an index value acquisition step of acquiring, based on the number, the entry time point, the exit time point, and the environment information, a first index value that is an index value of a deflection amount of the structure generated at the observation point, and a second index value that is an index value of a deflection amount at a designated position in the structure; and a deflection derivation step of deriving an estimated value of the deflection amount of the structure at the position based on the time-series data, the first index value, and the second index value.

A derivation device includes: an acquisition unit configured to acquire time-series data including a physical quantity generated at a predetermined observation point in a structure as a response caused by a movement of a formation moving object formed with one or more moving objects on the structure; an environment information acquisition unit configured to acquire, as environment information, information on a structure length that is a length of the structure, a moving object length that is a length of the moving object, and an installation position of a contact portion of the moving object with the structure; a time point derivation unit configured to derive an entry time point and an exit time point of the formation moving object with respect to the structure based on the time-series data; a number acquisition unit configured to acquire the number of the moving objects formed in the formation moving object; an index value acquisition unit configured to acquire, based on the number, the entry time point, the exit time point, and the environment information, a first index value that is an index value of a deflection amount of the structure generated at the observation point, and a second index value that is an index value of a deflection amount at a designated position in the structure; and a deflection derivation unit configured to derive an estimated value of the deflection amount of the structure at the position based on the time-series data, the first index value, and the second index value.

A derivation system includes a derivation device and a sensor. The derivation device includes: an acquisition unit configured to acquire time-series data including a physical quantity that is generated at a predetermined observation point in a structure as a response caused by a movement of a formation moving object formed with one or more moving objects on the structure and that is measured via the sensor; an environment information acquisition unit configured to acquire, as environment information, information on a structure length that is a length of the structure, a moving object length that is a length of the moving object, and an installation position of a contact portion of the moving object with the structure; a time point derivation unit configured to derive an entry time point and an exit time point of the formation moving object with respect to the structure based on the time-series data; a number acquisition unit configured to acquire the number of the moving objects formed in the formation moving object; an index value acquisition unit configured to acquire, based on the number, the entry time point, the exit time point, and the environment information, a first index value that is an index value of a deflection amount of the structure generated at the observation point, and a second index value that is an index value of a deflection amount at a designated position in the structure; and a deflection derivation unit configured to derive an estimated value of the deflection amount of the structure at the position based on the time-series data, the first index value, and the second index value.

A non-transitory computer-readable storage medium stores a program, and the program causes a computer to execute: an acquisition step of acquiring time-series data including a physical quantity generated at a predetermined observation point in a structure as a response caused by a movement of a formation moving object formed with one or more moving objects on the structure; an environment information acquisition step of acquiring, as environment information, information on a structure length that is a length of the structure, a moving object length that is a length of the moving object, and an installation position of a contact portion of the moving object with the structure; a time point derivation step of deriving an entry time point and an exit time point of the formation moving object with respect to the structure based on the time-series data; a number acquisition step of acquiring the number of the moving objects formed in the formation moving object; an index value acquisition step of acquiring, based on the number, the entry time point, the exit time point, and the environment information, a first index value that is an index value of a deflection amount of the structure generated at the observation point, and a second index value that is an index value of a deflection amount at a designated position in the structure; and a deflection derivation step of deriving an estimated value of the deflection amount of the structure at the position based on the time-series data, the first index value, and the second index value.

### BRIEF DESCRIPTION OF THE DRAWINGS

FIG. 1 is a block diagram showing a configuration of a derivation system.

FIG. 2 is a diagram showing a cross section of a bridge.

FIG. 3 is a diagram showing dimensions of a unit bridge girder.

FIG. 4 is a diagram showing dimensions of a railway vehicle.

FIG. 5 is a diagram showing an outline of the unit bridge girder.

FIG. 6 is a diagram showing a bending moment at the unit bridge girder.

FIG. 7 is a diagram showing an outline of deflection of the unit bridge girder caused by a wheel.

FIG. 8 is a diagram showing an outline of deflection of the unit bridge girder caused by the railway vehicle.

FIG. 9 is a diagram showing an outline of deflection of the unit bridge girder caused by a railway train.

FIG. 10 is a diagram showing the deflection of the unit bridge girder caused by the railway vehicle.

FIG. 11 is a diagram showing an FFT result of the deflection of the unit bridge girder.

FIG. 12 is a diagram showing the deflection of the unit bridge girder caused by the railway train after high-pass filter processing.

FIG. 13 is a diagram showing deflection of the unit bridge girder caused by each railway vehicle.

FIG. 14 is a diagram showing deflection of the unit bridge girder caused by each railway vehicle and the railway train.

FIG. 15 is a diagram showing details of elements of the derivation system.

FIG. 16 is a diagram showing time-series data subjected to low-pass filter processing.

FIG. 17 is a diagram showing derivation processing of an entry time point and an exit time point.

FIG. 18 is a diagram showing the derivation processing of the entry time point and the exit time point.

FIG. 19 is a flowchart showing the derivation processing.

FIG. 20 is a diagram showing an estimated value of a deflection amount.

FIG. 21 is a diagram showing an amplitude at a designated position.

FIG. 22 is a diagram showing an amplitude ratio.

FIG. 23 is a diagram showing an offset.

FIG. 24 is a diagram showing an estimated value of a deflection amount.

### DESCRIPTION OF EXEMPLARY EMBODIMENTS

Embodiments of the present disclosure will be described in the following order.

### (1) First Embodiment

### (1-1) Configuration of Derivation System

### (1-1-1) Outline of Derivation System

### (1-1-2) Deflection Model

### (1-1-3) Verification Experiment

### (1-1-4) Details of Elements

### (1-2) Derivation Processing

### (2) Second Embodiment

### (2-1) Configuration of Derivation System

### (2-1-1) Outline of Derivation System

### (2-1-2) Verification Experiment

### (2-1-3) Details of Elements

### (2-2) Derivation Processing

### (3) Other Embodiments

### (1) First Embodiment

### (1-1) Configuration of Derivation System

### (1-1-1) Outline of Derivation System

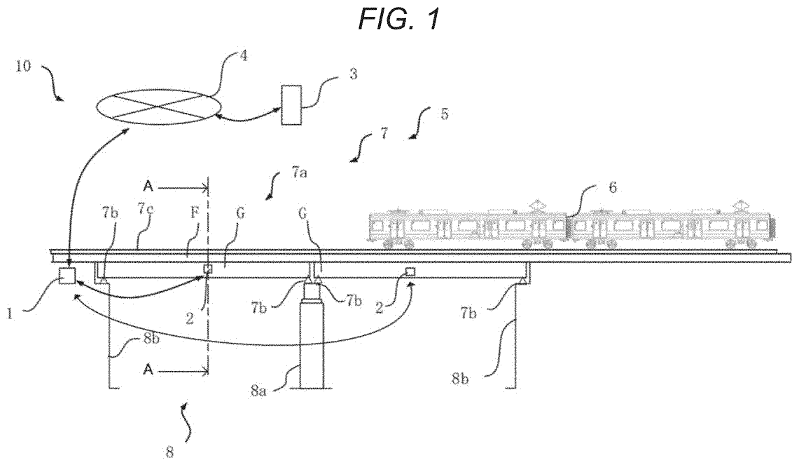

FIG. 1 is a block diagram showing an example of a configuration of a derivation system 10 according to the present embodiment. The derivation system 10 is a system that derives a deflection amount of a designated position 9, which is a designated position at a bridge 5, based on time-series data of a physical quantity at a predetermined observation point on the bridge 5 on which a railway train 6 formed with one or more railway vehicles moves. The railway train 6 is an example of a formation moving object. Each of the railway vehicles included in the railway train 6 is an example of a moving object. The bridge 5 is an example of a structure on which the moving object moves. Each railway vehicle of the railway train 6 moves on the bridge 5 via wheels provided on an axle. The wheel is an example of a contact portion between the railway vehicle and the bridge. In the present embodiment, each of the railway vehicles formed in the railway train 6 is a railway vehicle having the same structure. As shown in FIG. 1, the derivation system 10 includes a measurement device 1, at least one sensor device 2 provided in a superstructure 7 of the bridge 5, and a server device 3.

The measurement device 1 calculates deflection, that is, a displacement of the superstructure 7 caused by traveling of the railway train 6 based on acceleration data output from each sensor device 2. The measurement device 1 is installed on, for example, a bridge abutment 8b. The measurement device 1 and the server device 3 can communicate with each other via, for example, a wireless network of a mobile phone and a communication network 4 such as the Internet. The measurement device 1 transmits information on the displacement of the superstructure 7 caused by the traveling of the railway train 6 to the server device 3. The server device 3 derives the number of railway vehicles formed in the railway train 6 based on the transmitted displacement data.

In the present embodiment, the bridge 5 is a railroad bridge, and is, for example, a steel bridge, a girder bridge, or an RC bridge. The RC is an abbreviation for reinforced-concrete. In the present embodiment, the bridge 5 is a structure to which Bridge Weigh In Motion (BWIM) is applicable. The BWIM is a technology in which a bridge is regarded as a “scale”, deformation of the bridge is measured, and thereby a weight and the number of axles of a moving object passing through the bridge is measured. The bridge, which enables analysis of the weight of the moving object traveling on the bridge, based on a response such as deformation or strain of the bridge, is considered to be a structure to which BWIM is applicable. Therefore, the BWIM system, which applies a physical process between an action on the bridge and the response, enables the measurement of the weight of the moving object that travels on the bridge. The weight of the moving object is measured by measuring a correlation coefficient between the displacement and a load in advance, and using the correlation coefficient to derive the load of the moving object passing through from the measurement result of the displacement of the bridge when the moving object passes through.

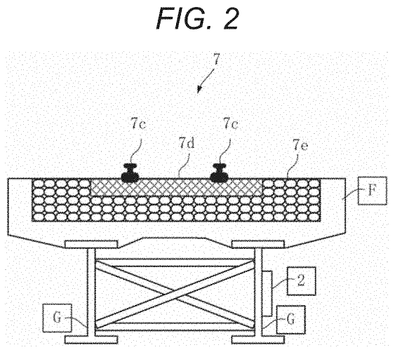

The bridge 5 includes the superstructure 7 that is a portion where the moving object moves, and a substructure 8 that supports the superstructure 7. FIG. 2 is a cross-sectional view of the superstructure 7 taken along a line A-A of FIG. 1. As shown in FIGS. 1 and 2, the superstructure 7 includes a bridge floor 7a, a support 7b, rails 7c, ties 7d, and a ballast 7e, and the bridge floor 7a includes a floor plate F, a main girder G, a cross girder which is not shown. As shown in FIG. 1, the substructure 8 includes bridge piers 8a and the bridge abutments 8b. The superstructure 7 is a structure across the bridge abutment 8b and the bridge pier 8a adjacent to each other, two adjacent bridge abutments 8b, or two adjacent bridge piers 8a. Hereinafter, the bridge abutment 8b and the bridge pier 8a are collectively referred to as a support portion. In the present embodiment, a set of support portions and a portion of the bridge girder of the superstructure 7 across the set of support portions are collectively referred to as one bridge girder. That is, a simple beam-like structure in which both ends are supported by two support portions is defined as one bridge girder. Therefore, the bridge 5 shown in FIG. 1 includes two bridge girders. Hereinafter, each bridge girder included in the bridge 5 is referred to as a unit bridge girder.

The measurement device 1 and the sensor device 2 are coupled to each other, for example, in a wired or wireless manner, and communicate with one another via a communication network such as a controller area network (CAN).

The sensor device 2 is used to measure a predetermined physical quantity used to derive a displacement (deflection) at an observation point set on the superstructure 7. In the present embodiment, the predetermined physical quantity is an acceleration. In the present embodiment, the sensor device 2 is installed at the observation point. The sensor device 2 includes an acceleration sensor such as a quartz acceleration sensor or a micro-electro-mechanical systems (MEMS) acceleration sensor. The sensor device 2 outputs acceleration data for deriving the displacement of the superstructure 7 caused by a movement of the railway train 6 which is a moving object at the observation point.

In the present embodiment, the sensor device 2 is installed at a central portion of the superstructure 7 in a longitudinal direction, specifically, at a central portion of the main girder G in the longitudinal direction. The sensor device 2 is not limited to being installed at the central portion of the superstructure 7 as long as the sensor device 2 can detect an acceleration for calculating the displacement of the superstructure 7. When the sensor device 2 is provided on the floor plate F of the superstructure 7, the sensor device 2 may be damaged due to traveling of the railway train 6, and the measurement accuracy may be affected by local deformation of the bridge floor 7a, so that in the example of FIGS. 1 and 2, the sensor device 2 is provided at the main girder G of the superstructure 7.

The floor plate F, the main girders G, and the like of the superstructure 7 are deflected in a vertical direction due to a load of the railway train 6 traveling on the superstructure 7. Each sensor device 2 measures an acceleration of the deflection of the floor plate F or the main girder G caused by the load of the railway train 6 traveling on the superstructure 7.

The designated position 9 is a position designated as a position of an estimation target of the deflection amount in the bridge 5.

### (1-1-2) Deflection Model

Here, a model of deflection of a bridge when a railway train moves on one bridge will be described. Here, the model is information such as an equation indicating a correspondence relationship between predetermined information and an estimation result.

In the following, the number of railway vehicles (the number of railway vehicles) formed in the railway train moving on the bridge is defined as N. An entry time point, which is a time point at which the railway train enters the bridge, is defined as tᵢ. Here, the entry of the railway train into the bridge means that the wheels of a first axle of a railway vehicle C₁ (a first railway vehicle from the head of the railway train) have entered the bridge. In the following, an exit time point, which is a time point at which the railway train exits from the bridge, is defined as tₒ. Here, the exit of the railway train from the bridge means that the wheels of a rearmost axle of a railway vehicle CN (the rearmost railway vehicle of the railway train) have exited from the bridge. In addition, in the following, a period during which the railway train passes through the bridge (a period from the time point tᵢ to the time point tₒ) is defined as tₛ. Hereinafter, N, tᵢ, tₒ, and tₛ are collectively referred to as observation information.

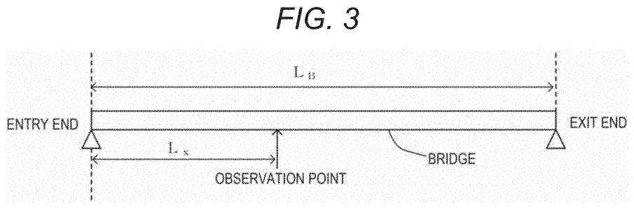

In the following description, a bridge length, which is a length of the bridge, is defined as LB. The bridge length is an example of a structure length. A distance from an end in a direction in which the railway train enters among ends of the bridge in the longitudinal direction to the observation point is defined as Lₓ. FIG. 3 shows the lengths L_{B} and Lₓ. In the following description, the end in a direction in which the railway train enters among the ends of the bridge in the longitudinal direction is referred to as an entry end. In addition, in the following, an end in a direction in which the railway train exits among the ends of the bridge in the longitudinal direction is referred to as an exit end. The vehicle length of the mth railway vehicle from the head of the railway train is defined as L_{c}(m). The vehicle length is an example of a moving object length. In the following, the lengths L_{c}(1) to L_{c}(N) are collectively referred to as a length L_{c}. The mth railway vehicle from the head of the railway train is defined as Cₘ. The number of axles in the railway vehicle Cₘ is defined as aᵣ(m). In the following, aᵣ(1) to aᵣ(N) are collectively referred to as aᵣ, and the aᵣ(m) axles in the railway vehicle Cₘ are defined as a first axle, a second axle, a third axle, . . . , an aᵣ(m)th axle in order from the head of the railway vehicle Cₘ.

A distance from a front end of the railway vehicle Cₘ in a traveling direction to the first axle is defined as Lₐ(a_{w}(m, 1)). Here, a_{w}(α, β) indicates a βth axle of the αth railway vehicle in the railway train. A distance from a (n−1)th axle to a nth axle in the railway vehicle Cₘ is defined as Lₐ(a_{w}(m, n)), n being an integer of 2 or more. That is, Lₐ(a_{w}(α, β)) indicates a distance between the βth axle and the (β-1)th axle in the railway train C_{α}, or a distance between the βth axle in the railway train C_{α}, and the front end of the railway train C_{β}, in the traveling direction. Hereinafter, Lₐ(a_{w}(1, 1)) to Lₐ(a_{w}(N, aᵣ(N))) are collectively referred to as Lₐ. Each Lₐ indicates a position of the corresponding axle in the corresponding railway vehicle. For example, Lₐ(a_{w}(m, 1)) indicates that the first axle is present behind the front end of the railway vehicle Cₘ by a distance of Lₐ(a_{w}(m, 1)). Lₐ(a_{w}(m, 2)) indicates that the second axle is present behind the first axle of the railway vehicle Cₘ by a distance of Lₐ (a_{w} (m, 2)).

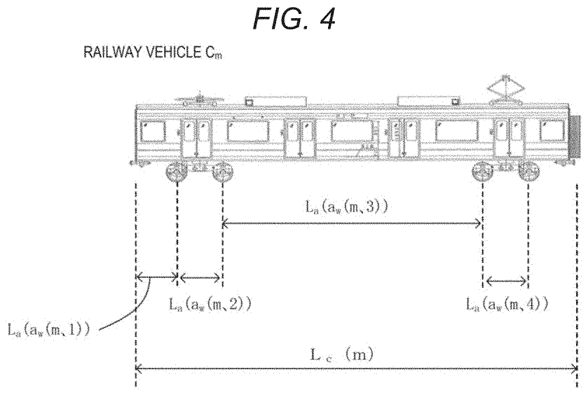

Here, a railway vehicle having a similar four-axle configuration is formed in the railway train. That is, aᵣ(m) is 4, m being 1, 2, . . . , N. FIG. 4 shows the lengths L_{c}(m), Lₐ(a_{w}(m, 1)), Lₐ(a_{w}(m, 2)), Lₐ(a_{w}(m, 3)), and Lₐ(a_{w}(m, 4)) in the railway vehicle Cₘ.

Hereinafter, L_{B}, Lₓ, L_{c}, aᵣ, and Lₐ are collectively referred to as environment information.

As shown in the following Equation (1), tₛ is obtained as a difference between tₒ and tᵢ.

tₛ=tₒ−tᵢ (1)

The total number Tar of wheels of the railway train is obtained by the following Equation (2).

$${T}_{{a}_{r}} = {\sum }_{m = 1}^{N} {a}_{r} ( m ) \qquad ( 2 )$$

A distance from the first axle of the railway vehicle C₁ at the head of the railway vehicle to the nth axle of the mth railway vehicle Cₘ is represented as D_{wa}(a_{w}(m, n)). D_{wa}(a_{w}(m, n)) is obtained from the following Equation (3).

$${D}_{wa} ( {a}_{w} ( m , n ) ) = {\sum }_{y = 1}^{m} {L}_{c} ( y ) + {\sum }_{x = 1}^{n} {L}_{a} ( {a}_{w} ( m , x ) ) - {L}_{c} ( m ) - {L}_{a} ( {a}_{w} ( 1 , 1 ) ) \qquad ( 3 )$$

The distance from the first axle of the railway vehicle C₁ at the head of the railway vehicle to the last axle aᵣ(N) of the rearmost railway vehicle CN is D_{wa}(a_{w}(N, aᵣ(N))). By using D_{wa}(a_{w}(N, aᵣ(N))), an average velocity vₐ of the railway train passing through the bridge is represented by the following Equation (4).

$${v}_{a} = \frac{{L}_{B}}{{t}_{s}} + \frac{{D}_{wa} ( {a}_{w} ( N , {a}_{r} ( N ) ) )}{{t}_{s}} \qquad ( 4 )$$

From Equation (3) and Equation (4), the following Equation (5) is established.

$${v}_{a} = \frac{{L}_{B}}{{t}_{s}} + \frac{1}{{t}_{s}} [ {\sum }_{y = 1}^{N} {L}_{c} ( y ) + {\sum }_{x = 1}^{{a}_{r} ( N )} {L}_{a} ( {a}_{w} ( N , x ) ) - {L}_{c} ( N ) - {L}_{a} ( {a}_{w} ( 1 , 1 ) ) ] \qquad ( 5 )$$

Next, deflection generated in the bridge when a load is applied to the bridge will be described.

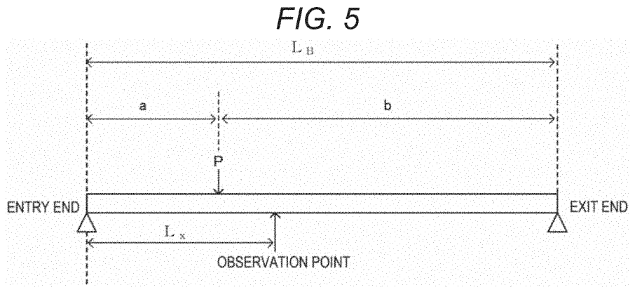

FIG. 5 is a schematic view of the bridge. FIG. 5 shows a situation in which a load P is applied to the bridge. Here, a distance between a position of the bridge to which the load P is applied and the entry end is represented by a. A distance between the position of the bridge to which the load P is applied and the exit end is represented by b. In this case, the bending moment at the position of the bridge to which the load P is applied is represented by the following Equation (6).

$$M = \frac{abP}{{L}_{B}} \qquad ( 6 )$$

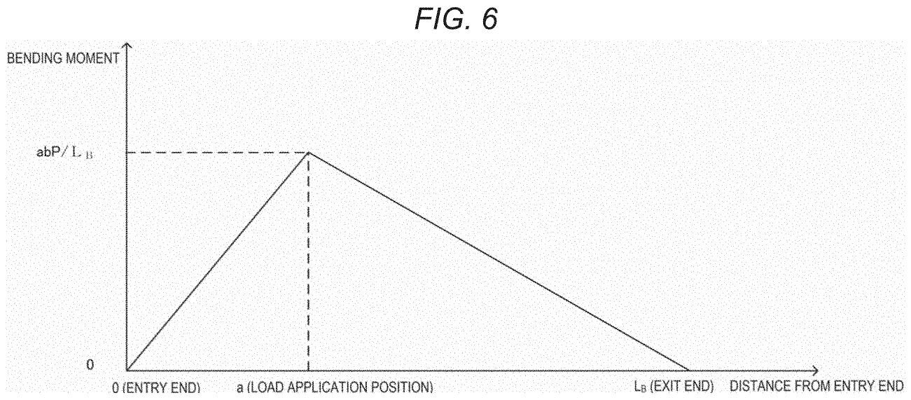

FIG. 6 shows the bending moment at each position of the bridge due to the load P. As shown in FIG. 6, the bending moment generated in the bridge due to the load P is 0 at the entry end, increases proportionally as the position approaches the position to which the load P is applied from the entry end, and becomes a value represented by Equation (6) at the position to which the load P is applied. The bending moment generated in the bridge due to the load P decreases proportionally as the position approaches the exit end from the position to which the load P is applied, and becomes 0 at the exit end. Therefore, the bending moment at an optional position X in the bridge is represented by the following Equation (7).

$$M = \frac{bP}{{L}_{B}} x - {H}_{a} P ( x - a ) \qquad ( 7 )$$

In Equation (7), x represents the distance from the entry end to the position X in the traveling direction of the railway train. Ha in Equation (7) is a value represented by the following Equation (8).

$${H}_{a} = \{ \begin{matrix}x \leq a : & 0 \\ x > a : & 1\end{matrix} \qquad ( 8 )$$

Between the bending moment and a deflection w of the bridge at the optional position X, a relationship represented by the following Equation (9) is established.

$$- M = EI \frac{d θ}{dx} = EI \frac{{d}^{2} w}{{dx}^{2}} \qquad ( 9 )$$

θ in Equation (9) is an angle formed by a horizontal line and the deflected bridge at the position X. From Equation (7) and Equation (9), the following Equation (10) is established.

$$\frac{{d}^{2} w}{{dx}^{2}} = - \frac{1}{EI} ( \frac{bP}{{L}_{B}} x - {H}_{a} P ( x - a ) ) \qquad ( 10 )$$

By integrating both sides of Equation (10) twice with x, the following Equation (11) representing the deflection w at the position X is obtained.

$$w = \frac{P}{6 {EIL}_{B}} \{ - {bx}^{3} + {H}_{a} {{L}_{B} ( x - a )}^{3} + g 1 x + g 2 \} \qquad ( 11 )$$

In Equation (11), g1 and g2 are constant terms. Here, since the bridge is supported by the entry end and the exit end, no deflection is generated at the positions of the entry end and the exit end. That is, in Equation (11), when x=0 and x=L_{B}, both sides are 0. Therefore, g1 and g2 are represented by the following Equation (12) and Equation (13).

g1=ab(a+2b) (12)

g2=0 (13)

From Equation (11), Equation (12), and Equation (13), the following Equation (14) representing the deflection w at the position X is obtained.

$$w = \frac{P}{6 {EIL}_{B}} \{ - {bx}^{3} + {H}_{a} {{L}_{B} ( x - a )}^{3} + ab ( a + 2 b ) x \} \qquad ( 14 )$$

When the load P is applied to a center of the bridge in the longitudinal direction, the maximum deflection among the deflection generated in the bridge due to the application of the load P is generated at the center of the bridge in the longitudinal direction. When this maximum deflection is w_{0.51}, an equation representing w_{0.51} is obtained. When the load P is applied to the center of the bridge in the longitudinal direction, a=b=0.5L_{B}. Since the position X of a target for which the deflection is to be obtained is the center of the bridge in the longitudinal direction, x=0.5L_{B}. In this case, since x≤a, Hₐ=0 is obtained from Equation (8). By substituting x=0.5L_{B}, a=b=0.5L_{B}, and Hₐ=0 into Equation (14), the following Equation (15) representing the deflection w_{0.51} is obtained.

$${w}_{0.5 l} = \frac{P}{48 EI} {L}_{B}^{3} \qquad ( 15 )$$

The deflection at an optional position in the bridge represented by Equation (14) is normalized using w_{0.51}.

When the position of the load P exists on the entry end side with respect to the position X, that is, when x>a, Hₐ=1 is obtained from Equation (8), and Equation (14) is represented as Equation (16) below.

$$w = \frac{P}{6 {EIL}_{B}} \{ - {bx}^{3} + {{L}_{B} ( x - a )}^{3} + ab ( a + 2 b ) x \} \qquad ( 16 )$$

a=L_{B}r. Here, r is a real number from 0 to 1. Since b=L_{B}−a, b is represented as b=L_{B}(1−r). When a=L_{B}r and b=L_{B}(1−r) are substituted into Equation (16) and the deflection is normalized by dividing by w_{0.51}, the following Equation (17) representing a normalized deflection amount w_{std} at the position X when x>a is obtained.

$${w}_{std} = \frac{8}{{L}_{B}} \{ {xr}^{3} + ( \frac{{x}^{3}}{{L}_{B}^{2}} + 2 x ) r \} - \frac{8}{{L}_{B}} \{ {L}_{B} {r}^{3} + \frac{3 {x}^{2}}{{L}_{B}} r \} \qquad ( 17 )$$

Similarly, when the position of the load P exists on the exit end side with respect to the position X, that is, when x≤a, Hₐ=0 is obtained from Equation (8), and Equation (14) is represented as the following Equation (18).

$$w = \frac{P}{6 {EIL}_{B}} \{ - {bx}^{3} + ab ( a + 2 b ) x \} \qquad ( 18 )$$

a=L_{B}r. Here, r is a real number from 0 to 1. Since b=L_{B}−a, b is represented as b=L_{B}(1−r). When a=L_{B}r and b=L_{B}(1−r) are substituted into Equation (18) and the deflection is normalized by dividing by w_{0.51}, the following Equation (19) representing the normalized deflection amount w_{std} at the position X when x≤a is obtained.

$${w}_{std} = \frac{8}{{L}_{B}} \{ {xr}^{3} + ( \frac{{x}^{3}}{{L}_{B}^{2}} + 2 x ) r \} - \frac{8}{{L}_{B}} \{ 3 {xr}^{2} + \frac{{x}^{3}}{{L}_{B}^{2}} \} \qquad ( 19 )$$

By substituting Lₓ for x in Equation (17) and Equation (19), the normalized deflection amount w_{std} at the deflection observation point is represented as the following Equation (20) as a function of r.

$${w}_{std} ( r ) = \frac{8}{{L}_{B}} \{ {L}_{x} {r}^{3} + ( \frac{{L}_{x}^{3}}{{L}_{B}^{2}} + 2 {L}_{x} ) r - R ( r ) \} \qquad ( 20 )$$

The function R(r) in Equation (20) is a function represented by the following Equation (21).

$$R ( r ) = \{ \begin{matrix}{L}_{x} > {L}_{B} r : & {L}_{B} {r}^{3} + \frac{3 {L}_{x}^{2}}{{L}_{B}} r \\ {L}_{x} \leq {L}_{B} r : & 3 {L}_{x} {r}^{2} + \frac{{L}_{x}^{3}}{{L}_{B}^{2}}\end{matrix} \qquad ( 21 )$$

Here, using Equation (20) and Equation (21), a function indicating a temporal change in deflection generated at an observation point due to a load applied to the bridge via a wheel of any one axle a_{w}(m, n) is obtained. First, a period required for the wheel of one axle of the railway train to reach the observation point from the entry end is defined as tₓₙ. tₓₙ is obtained from Lₓ and vₐ by the following Equation (22).

$${t}_{xn} = \frac{{L}_{x}}{{v}_{a}} \qquad ( 22 )$$

A period during which one wheel of the railway train crosses the bridge, that is, a period from the entry end to the exit end is defined by tₗₙ. tₗₙ is obtained from L_{B} and vₐ by the following Equation (23).

$${t}_{ln} = \frac{{L}_{B}}{{v}_{a}} \qquad ( 23 )$$

A time point at which the wheel of the nth axle a_{w}(m, n) of the mth railway vehicle of the railway train reaches the entry end is defined as tₒ (m, n). tₒ (m, n) is obtained from tᵢ, vₐ, and D_{wa}(a_{w}(m, n)) by the following Equation (24).

$${t}_{0} ( m , n ) = {t}_{i} + \frac{{D}_{wa} ( {a}_{w} ( m , n ) )}{{v}_{a}} \qquad ( 24 )$$

From Equation (22), Lₓ is represented as the following Equation (25).

Lₓ=vₐtₓₙ (25)

From Equation (23), L_{B} is represented as the following Equation (26).

L_{B}=vₐtₗₙ (26)

The position of the axle a_{w}(m, n) is a load position. Therefore, the position of the axle a_{w}(m, n) is a position at a distance of a=L_{B}r in the direction from the entry end to the exit end. When a variable indicating the time point is t, a distance from the entry end of a_{w}(m, n) at the time point t is equal to a distance traveled by the railway vehicle from the time point tₒ(m, n) to the time point t. Therefore, the following Equation (27) is established.

L_{B}r=vₐ(t−t₀(m,n)) (27)

From Equation (27), r is represented as in the following Equation (28).

$$r = \frac{{v}_{a} ( t - {t}_{0} ( m , n ) )}{{L}_{B}} = \frac{{v}_{a} ( t - {t}_{0} ( m , n ) )}{{v}_{a} {t}_{ln}} = \frac{( t - {t}_{0} ( m , n ) )}{{t}_{ln}} \qquad ( 28 )$$

By replacing Lₓ, L_{B}, and r in Equation (20) and Equation (21) using Equation (25), Equation (26), and Equation (28), a function w_{std}(a_{w}(m, n), t) in the following Equation (29) is obtained as a model indicating a temporal change in deflection generated at the observation point due to the load applied to the bridge via the wheel of the axle a_{w}(m, n). A function R(t) in Equation (29) is a function represented by the following Equation (30).

$${w}_{std} ( {a}_{w} ( m , n ) , t ) = \{ \begin{matrix}\begin{matrix}t < {t}_{0} ( m , n ) : 0 \\ \begin{matrix}{t}_{0} ( m , n ) \leq t \leq {t}_{0} ( m , n ) + {t}_{ln} : \\ \frac{8}{{t}_{ln}} \{ {{t}_{xn} ( \frac{t - {t}_{0} ( m , n )}{{t}_{ln}} )}^{3} + ( \frac{{t}_{xn}^{3}}{{t}_{ln}^{2}} + 2 {t}_{xn} ) ( \frac{t - {t}_{0} ( m , n )}{{t}_{ln}} ) - R ( t ) \}\end{matrix}\end{matrix} \\ {t}_{0} ( m , n ) + {t}_{ln} < t : 0\end{matrix} \qquad ( 29 )$$

$$R ( t ) = \{ \begin{matrix}\begin{matrix}\begin{matrix}t < {t}_{0} ( m , n ) : 0 \\ \begin{matrix}{t}_{0} ( m , n ) \leq t \leq {t}_{0} ( m , n ) + {t}_{ln} ⋂ {t}_{xn} > t - {t}_{0} ( m , n ) : \\ {{t}_{ln} ( \frac{t - {t}_{0} ( m , n )}{{t}_{ln}} )}^{3} + \frac{3 {t}_{xn}^{2}}{{t}_{ln}} ( \frac{t - {t}_{0} ( m , n )}{{t}_{ln}} )\end{matrix}\end{matrix} \\ {t}_{0} ( m , n ) \leq t \leq {t}_{0} ( m , n ) + {t}_{ln} ⋂ {t}_{xn} \leq t - {t}_{0} ( m , n ) :\end{matrix} \\ 3 {{t}_{xn} ( \frac{t - {t}_{0} ( m , n )}{{t}_{ln}} )}^{2} + \frac{{t}_{xn}^{3}}{{t}_{ln}^{2}} \\ {t}_{0} ( m , n ) + {t}_{ln} < t : 0\end{matrix} \qquad ( 30 )$$

When the observation information and the environment information (tᵢ, tₒ, N, L_{B}, Lₓ, L_{c}(1) to L_{c}(N), aᵣ(1) to aᵣ(N), and Lₐ(a_{w}(1, 1)) to Lₐ(a_{w}(N, aᵣ(N)))) are known, w_{std}(a_{w}(m, n), t) is obtained using the information. For example, tₛ is obtained from tᵢ and tₒ using Equation (1). From tₛ, N, aᵣ, Lₐ, and L_{c}, vₐ is obtained using Equation (5). From vₐ, L_{B}, and Lₓ, tₓₙ and tₗₙ are obtained using Equation (22) and Equation (23). From Lₐ, L_{c}, and tᵢ, tₒ(m, n) is obtained using Equation (3) and Equation (24). Then, by substituting the obtained tₓₙ, tₗₙ, and tₒ(m, n) into the Equation (29) and Equation (30), the function w_{std}(a_{w}(m, n), t) of t is obtained.

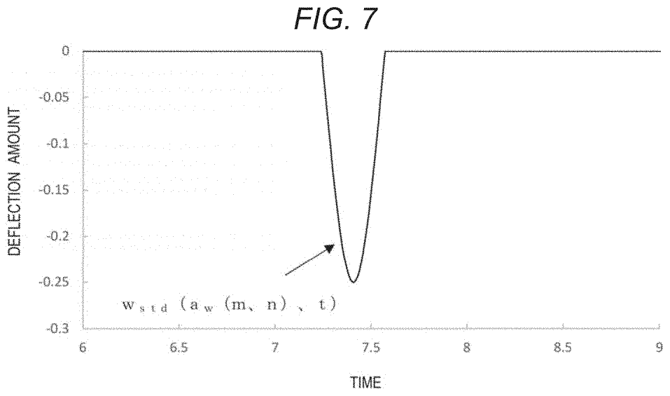

An example of a change in the deflection amount at the observation point indicated by w_{std}(a_{w}(m, n), t) is shown in FIG. 7. In a graph of FIG. 7, a horizontal axis represents time, and a vertical axis represents the deflection amount. In accordance with the movement of one railway vehicle Cₘ, a set of wheels for each of the aᵣ(m) axles moves on the bridge. Therefore, a function C_{std}(m, t) serving as a model indicating a temporal change in the deflection amount generated at the observation point due to the movement of one railway vehicle Cₘ is obtained as the sum of w_{std}(a_{w}(m, n), t) for the respective axles as in the following Equation (31).

$${C}_{std} ( m , t ) = {\sum }_{n = 1}^{{a}_{r} ( m )} {w}_{std} ( {a}_{w} ( m , n ) , t ) \qquad ( 31 )$$

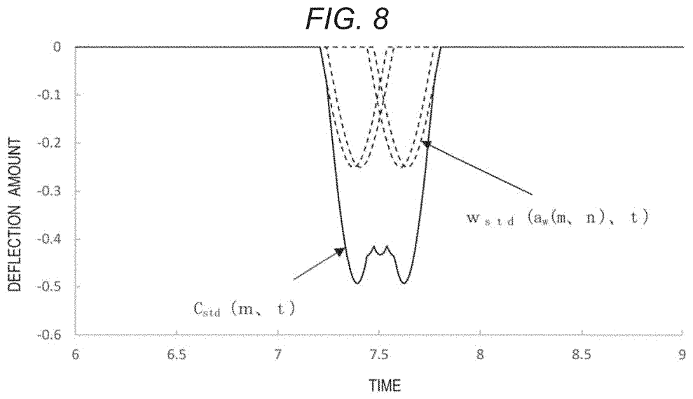

FIG. 8 shows how the deflection amount changes at the observation point indicated by the function C_{std}(m, t) when aᵣ(m) is 4, that is, when the railway vehicle Cₘ has a four-axle configuration. In a graph of FIG. 8, a horizontal axis represents time, and a vertical axis represents the deflection amount. A solid line in the graph of FIG. 8 indicates C_{std}(m, t), and each dotted line in the graph indicates w_{std}(a_{w}(m, n), t) for each axle.

In accordance with the movement of the railway train, the N railway vehicles move on the bridge. Therefore, a function T_{std}(t) serving as a model indicating a temporal change in the deflection amount generated at the observation point due to movement of one railway train is obtained as the sum of C_{std}(m, t) for the respective railway vehicles as in the following Equation (32).

$${T}_{std} ( t ) = {\sum }_{m = 1}^{N} {C}_{std} ( m , t ) \qquad ( 32 )$$

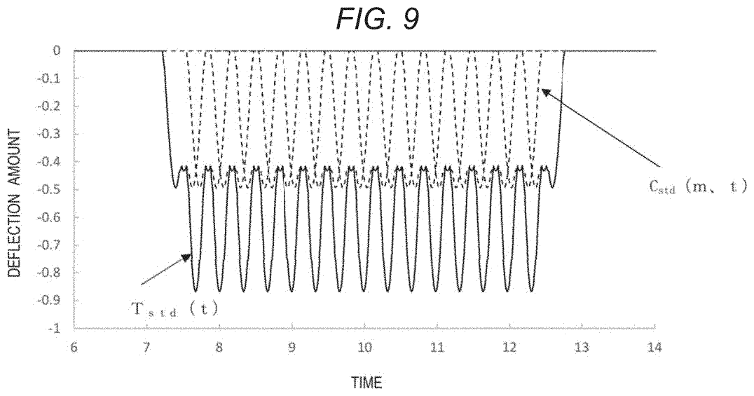

FIG. 9 shows how the deflection amount changes at the observation point indicated by the function T_{std}(t) when N is 16, that is, when 16 railway vehicles are formed in the railway train. In a graph of FIG. 9, a horizontal axis represents time, and a vertical axis represents the deflection amount. A solid line in the graph of FIG. 9 indicates T_{std}(t), and each dotted line in the graph indicates C_{std}(m, t) for each railway vehicle. As shown in the graph of FIG. 9, the waveform is obtained by adding together the deflection of each passing railway vehicle, and it can be seen that vibration occurs in a cycle in which continuous railway vehicles pass through the bridge.

The deflection model of the bridge is described as above. As described above, the model of the deflection in the present embodiment is an equation based on the simple beam-like structure of the bridge.

### (1-1-3) Verification Experiment

The inventors obtained the deflection amount T_{std}(t) under conditions that the observation information and the environment information have the following values. That is, N=4, tᵢ=7.21 [sec], tₒ=8.777 [sec], tₛ=1.567 [sec], L_{B}=25 [in] Lₓ=12.5 [m] L_{c}=25 [m], aᵣ=4, Lₐ (a_{w} (m, 1))=2.5 [m] for each of m=1 to N, Lₐ(a_{w}(m, 2))=2.5 [m] for each of m=1 to N, Lₐ(a_{w}(m, 3))=15 [m] for each of m=1 to N, and Lₐ(a_{w}(m, 4))=2.5 [m] for each of m=1 to N.

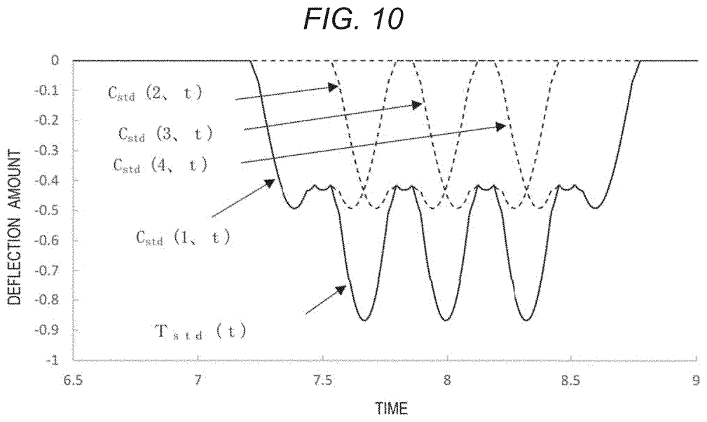

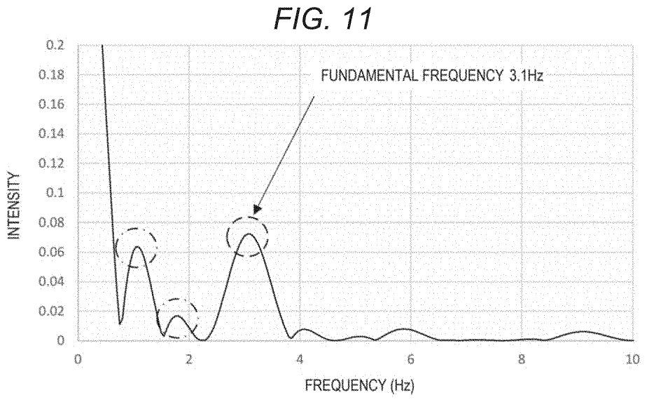

The deflection amount T_{std}(t) at this time is shown in FIG. 10. In a graph of FIG. 10, a horizontal axis represents time, and a vertical axis represents the deflection amount. The inventors also obtained an intensity of each frequency component included in T_{std}(t) by performing fast Fourier transform (FFT) on the obtained T_{std}(t). A result of the FFT for T_{std}(t) is shown in FIG. 11. In a graph of FIG. 11, a horizontal axis represents the frequency, and a vertical axis represents the intensity of the corresponding frequency component. Then, the inventors obtained a fundamental frequency F_{f} of T_{std}(t) from the result of the FFT of T_{std}(t) as the frequency of the vibration occurring in the bridge in accordance with the movement of the continuous railway vehicles. Here, the fundamental frequency is a frequency of a component having the lowest frequency included in the signal. Specifically, the inventors specified a peak corresponding to the lowest frequency from the result of the FFT of T_{std}(t) except for a side lobe generated due to an influence of a window function used in the FFT, and obtained the specified peak as the fundamental frequency. In the example of FIG. 11, as indicated by portions surrounded by one-dot chain lines, two peaks of the side lobes generated due to the influence of the window function used in the FFT are observed in a range of less than 2 Hz. The inventors specified a peak in a portion surrounded by a dotted line as a peak having the lowest frequency among the peaks excluding these peaks, and obtained a frequency corresponding to the specified peak as the fundamental frequency F_{f}. The inventors obtained a fundamental frequency of 3.1 Hz from the graph of FIG. 11.

The inventors obtained a wave number ν of the fundamental frequency F_{f} included in a passing period tₛ by using the following Equation (33).

ν=tₛF_{f} (33)

In this case, ν=1.567×3.1=4.8577. Here, the number N of railway vehicles of the moving railway train is 4. The inventors found a feature that the wave number ν of the fundamental frequency F_{f} included in the passing period tₛ is a value higher than N by about one. Hereinafter, this feature is referred to as a first feature. Therefore, the inventors found that the number N of railway vehicles included in a railway train can be obtained by using the following Equation (34), assuming that the number N of railway vehicles included in the railway train can be obtained as a value obtained by rounding, to an integer, a value obtained by subtracting one from the wave number ν of the fundamental frequency F_{f} included in the passing period tₛ. A round function is a function that returns a value obtained by rounding off an argument.

N=round(v−1) (34)

The inventors obtained a fundamental cycle T_{f} from the fundamental frequency F_{f} by using the following Equation (35).

$${T}_{f} = \frac{1}{{F}_{f}} \qquad ( 35 )$$

Then, the inventors performed low-pass filter processing for attenuating a component of a frequency equal to or higher than the fundamental frequency on T_{std}(t) by performing a moving average on the deflection amount T_{std}(t) in the fundamental cycle T_{f}. The low-pass filter processing may be processing of applying another FIR filter that attenuates the component of the frequency equal to or higher than the fundamental frequency. T_{std}(t) subjected to the low-pass filter processing is defined as T_{std_1p}(t)=T_{std_1p}(kΔT). Here, k is a variable indicating what number of observations when the deflection amount is observed in a cycle at the observation point. That is, when a data cycle (time resolution) of the observation of the deflection amount is ΔT, t=kΔT.

As shown in the following Equation (36), a moving average interval k_{mf} adjusted to the time resolution of the data is obtained from the fundamental cycle T_{f} and ΔT.

$${k}_{mf} = 2 ⌊ \frac{{T}_{f}}{2 Δ T} ⌋ + 1 \qquad ( 36 )$$

By using k_{mf}, T_{std_1p}(t) is obtained by the following

Equation (37).

$${T}_{std \_ lp} ( t ) = {T}_{std \_ lp} ( k Δ T ) = \frac{1}{{k}_{mf}} {\sum }_{n = k - \frac{{k}_{mf} - 1}{2}}^{k + \frac{{k}_{mf} - 1}{2}} {T}_{std} ( n Δ T ) \qquad ( 37 )$$

The inventors performed high-pass filter processing for attenuating a component of a frequency lower than the fundamental frequency on T_{std}(t) by subtracting T_{std_1p}(t) from the deflection amount T_{std}(t). The high-pass filter processing may be processing of applying another FIR filter that attenuates the component of the frequency lower than the fundamental frequency. T_{std}(t) subjected to the high-pass filter processing is defined as T_{std_hp}(t). Specifically, the inventors obtained T_{std_hp} (t) by subtracting T_{std_1p}(t) from T_{std}(t) as shown in the following Equation (38).

T_{std_hp}(t)=T_{std}(kΔT)−T_{std_1p}(t) (38)

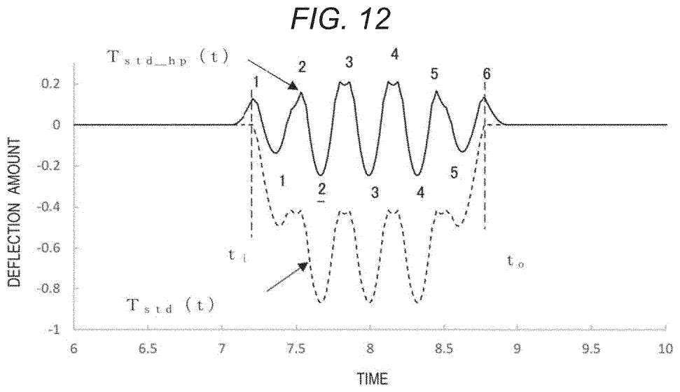

The obtained T_{std_hp}(t) is superimposed on T_{std}(t) and shown in FIG. 12. In a graph of FIG. 12, a horizontal axis represents time (t=kΔT), and a vertical axis represents the deflection amount. A solid line in the graph of FIG. 12 indicates T_{std_hp}(k), and a dotted line in the graph indicates T_{std}(t).

From the graph of FIG. 12, the number of positive peaks of T_{std_hp}(t) in the passing period tₛ (period from the time point tᵢ to the time point tₒ) is 6. Here, the positive peak is a peak that is convex in an upward direction of the bridge among the peaks of T_{std_hp}(t). The number of negative peaks of T_{std_hp}(t) in the passing period tₛ is 5. Here, the negative peak is a peak that is convex in a downward direction of the bridge among the peaks of T_{std_hp}(t). Accordingly, the inventors found a feature that the number (6) of positive peaks of T_{std_hp}(t) in the passing period tₛ is larger by two than the number N (4) of the railway vehicles included in the railway train, and the number (5) of the negative peaks is larger by one than N(4). Hereinafter, this feature is referred to as a second feature.

The inventors verified whether the first feature and the second feature are satisfied while changing the observation information and the environment information to various values. As a result, the inventors found that the first feature and the second feature are satisfied when L_{c}/2<L_{B}<3L_{c}/2 is satisfied. The inventors found that, based on the first feature and the second feature, it is possible to derive the number of railway vehicles formed in the railway train 6 from time-series data of the displacement (deflection) of the bridge at the observation point of the bridge. Hereinafter, the time-series data of the displacement at the observation point of the bridge is defined as u(t). u(t) is data of discrete values of displacement measured in a predetermined cycle, and is data in which each discrete value is associated with a measurement time point.

The inventors considered deflection amounts C_{std}(1, t) to C_{std}(N, t) and T_{std}(t) generated when a railway train formed with the same railway vehicles passes through the bridge under conditions in which the observation information and the environment information have the following values. That is, N=4, tᵢ=7.21 [sec], tₒ=8.777 [sec], tₛ=1.567 [sec], L_{B}=25 [m], Lₓ=12.5 [m], L_{c}=25 [m], aᵣ=4, Lₐ (a_{w}(m, 1))=2.5 [m] for each of m=1 to N, Lₐ(a_{w}(m, 2))=2.5 [m] for each of m=1 to N, Lₐ(a_{w}(m, 3))=15 [m] for each of m=1 to N, and Lₐ(a_{w}(m, 4))=2.5 [m] for each of m=1 to N.

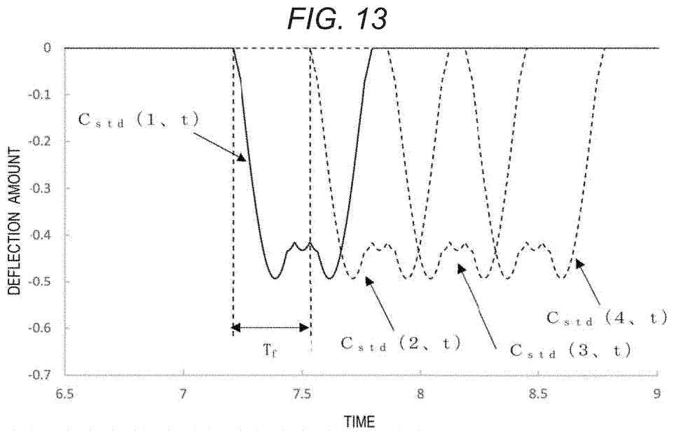

The deflection amounts C_{std}(1, t) to C_{std}(4, t) by four railway vehicles included in the railway train at this time are shown in FIG. 13. A cycle of vibration generated in the bridge when the railway vehicles continuously pass through the bridge is defined as T_{f}. The vibration generated in the bridge when the railway vehicles continuously pass through the bridge is vibration generated when the continuous railway vehicles pass through the bridge. For this reason, the cycle T_{f} is a time difference between the entry time points of the continuous railway vehicles passing through the bridge into the bridge. Since the bridge is deflected by the railway vehicle from the time point when the railway vehicle enters the bridge, the time difference between a start time point of the deflection indicated by C_{std}(m, t) and a start time point of the deflection indicated by C_{std}(m+1, t) is the cycle T_{f}. FIG. 13 shows the deflection generated in the bridge due to the passage of each railway vehicle of the railway train when the railway train passes through the bridge. In a graph of FIG. 13, a horizontal axis represents time, and a vertical axis represents the deflection amount. As shown in FIG. 13, the deflection due to the passing of the railway vehicles in front and rear occurs at a time difference of T_{f}.

Since the cycle T_{f} is a time difference between the entry time points of the continuous railway vehicles passing through the bridge into the bridge, as shown in the following Equation (39), the cycle T_{f} can be regarded as a period during which the railway vehicle having a vehicle length L_{c}(m) passes through at a velocity vₐ.

$${T}_{f} = \frac{{L}_{C} ( m )}{{v}_{a}} \qquad ( 39 )$$

A period during which the railway vehicle Cₘ of the railway train passes through the bridge is defined as t_{c}(m). t_{c}(m) is an example of a moving object passing period, which is a period during which the railway vehicle Cₘ which is a moving object passes through a bridge which is a structure. t_{c}(m) is a period from the time point when the first axle of the railway vehicle Cₘ reaches the entry end to the time point when the aᵣ(m)th axle of the railway vehicle Cₘ reaches the exit end. That is, t_{c}(m) is a period during which the railway vehicle Cₘ moves by a total distance of the bridge length L_{B} and the distance from the first axle which is the foremost axle of the railway vehicle Cₘ to the aᵣ(m)th axle which is the rearmost axle of the railway vehicle Cₘ Therefore, t_{c}(m) is represented by the following Equation (40).

$${t}_{c} ( m ) = \{ {L}_{B} + {\sum }_{n = 1}^{{a}_{r} ( m )} {L}_{a} ( {a}_{w} ( m , n ) ) - {L}_{a} ( {a}_{w} ( m , 1 ) ) \} / {v}_{a} \qquad ( 40 )$$

When the railway train passes through the bridge, the number of railway vehicles for which the subsequent railway vehicle is present among the railway vehicles formed in the railway train is defined as C_{Tn}. Among the railway vehicles formed in the railway train, for the railway vehicles other than the rearmost railway vehicle, there is a subsequent railway vehicle. Therefore, C_{Tn} is a number smaller than N by 1. That is, the following Equation (41) is established.

tₛ=C_{Tn}T_{f}+t_{c}(m) (41)

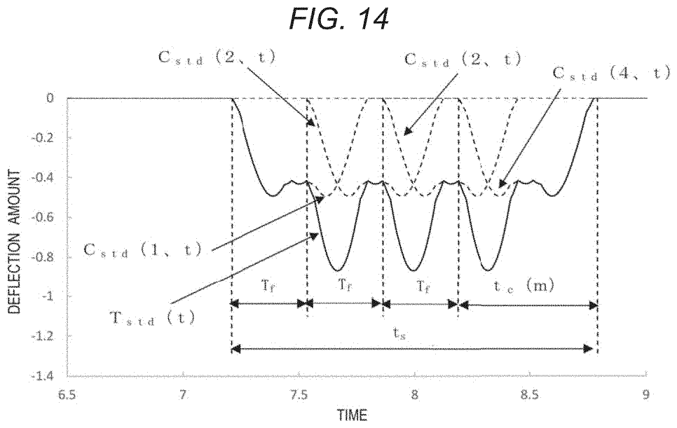

FIG. 14 shows C_{std}(1, t) to C_{std}(N, t) and T_{std}(t). In a graph of FIG. 14, a horizontal axis represents time, and a vertical axis represents the deflection amount. A solid line in the graph of FIG. 14 indicates T_{std}(t), and dotted lines in the graph indicate C_{std}(1, t) to C_{std}(4, t). As shown in FIG. 14, the passing period tₛ is the sum of C_{Tn} T_{f}s and a period t_{c}(m) during which one railway vehicle Cₘ passes through the bridge. That is, the following Equation (42) is established.

N=C_{Tn}+1 (42)

From Equation (41) and Equation (42), the number N of railway vehicles formed in the railway train is represented by the following Equation (43).

$$N = \frac{{t}_{s} - {t}_{c} ( m )}{{T}_{f}} + 1 \qquad ( 43 )$$

T_{f} is also a period required for the railway train to move by the vehicle length of one railway vehicle. Therefore, the distance by which the railway train travels during the passing period tₛ is the sum of the length of the (N−1) railway vehicles and the distance by which the railway train travels during the period t_{c}(m) at the velocity vₐ. Therefore, the following Equation (44) is established.

$${v}_{a} = \frac{( N - 1 ) {L}_{C} ( m ) + {t}_{c} ( m ) {v}_{a}}{{t}_{s}} \qquad ( 44 )$$

From Equation (44), the following Equation (45) is established. From Equation (45), it can be confirmed that Equation (43) is established.

$$( N - 1 ) = \frac{{v}_{a} {t}_{s} - {t}_{c} ( m ) {v}_{a}}{{L}_{C} ( m )} = \frac{{t}_{s} - {t}_{c} ( m )}{\frac{{L}_{C} ( m )}{{v}_{a}}} = \frac{{t}_{s} - {t}_{c} ( m )}{{T}_{f}} \qquad ( 45 )$$

It is considered that the deflection amount T_{std}(t) generated in the bridge when the railway train passes through the bridge includes, as a component of the fundamental frequency F_{f}, a component of vibration generated in the bridge in accordance with the movement of the continuous railway vehicles. F_{f} is also the frequency of the vibration generated in the bridge in accordance with the movement of the continuous railway vehicle, and thus can be represented as a reciprocal of T_{f} as shown in the following Equation (46).

$${F}_{f} = \frac{1}{{T}_{f}} \qquad ( 46 )$$

From Equation (39) and Equation (46), the velocity vₐ is represented by a product of F_{f} and L_{c}(m) as in the following Equation (47).

vₐ=F_{f}L_{c}(m) (47)

Therefore, t_{c}(m) represented by Equation (40) is a value obtained by dividing the total distance of the bridge length L_{B} and the distance from the first axle which is the foremost axle of the railway vehicle Cₘ to the aᵣ(m)th axle which is the rearmost axle by the product of F_{f} and L_{c}(m).

From Equation (43) and Equation (46), the number N of railway vehicles formed in the railway train is represented as a value obtained by adding one to the product of the fundamental frequency F_{f} and a value obtained by subtracting the passing period t_{c}(m) of one railway vehicle Cₘ passing through the bridge from the passing period tₛ of the railway train passing through the bridge, and is represented by the following Equation (48).

N=(tₛ−t_{c}(m))F_{f}+1 (48)

The inventors found that the average velocity vₐ of the railway train is represented by the product of the fundamental frequency F_{f} and the length of one railway vehicle Cₘ included in the railway train, as represented by Equation (47). In addition, the inventors found that the period t_{c}(m) during which one railway vehicle Cₘ passes through the bridge is represented as a period during which the railway vehicle Cₘ moves a length of the sum of the length L_{B} of the bridge and the distance from the first axle of the railway vehicle Cₘ to the aᵣ(m)th axle at the velocity vₐ, as represented by Equation (40). Further, the inventors found that the number N of railway vehicles formed in the railway train is represented as a value obtained by adding one to the product of the fundamental frequency F_{f} and a value obtained by subtracting t_{c}(m) from tₛ, as represented by Equation (48).

Then, the inventors conceived a method of deriving the number of railway vehicles formed in the railway train by using time-series data of a displacement at an observation point set on a bridge on which the railway train moves.

The method conceived by the inventors is a method of acquiring time-series data u(t) of the displacement at the observation point set on the bridge on which a railway train moves, acquiring L_{B}, L_{c}, and Lₐ as the environment information, acquiring the fundamental frequency F_{f} of u(t) as a frequency of vibration generated in the bridge due to the passage of the continuous railway vehicles formed in the railway train based on the time-series data u(t), deriving the passing period tₛ of the railway train passing through the bridge based on u(t), and deriving the number of railway vehicles included in the railway train based on L_{B}, L_{c}, Lₐ, F_{f}, and is using the relationships represented by Equation (40), Equation (47), and Equation (48).

In the present embodiment, the derivation system 10 derives the value of the number N of railway vehicles formed in the railway train 6 based on the time-series data u(t) of the deflection amount of the bridge 5 measured at the observation point by using the knowledge obtained by the experiment. Then, the derivation system 10 derives the deflection amount at the observation point and the deflection amount of the bridge 5 at the designated position 9, which is a designated position, by using the derived N and the deflection model of the bridge. The derivation system 10 obtains a product of a ratio of the deflection amount at the designated position to the derived deflection amount at the observation point and the time-series data u(t) as an estimated value of the actual deflection amount at the designated position 9.

### (1-1-4) Details of Elements

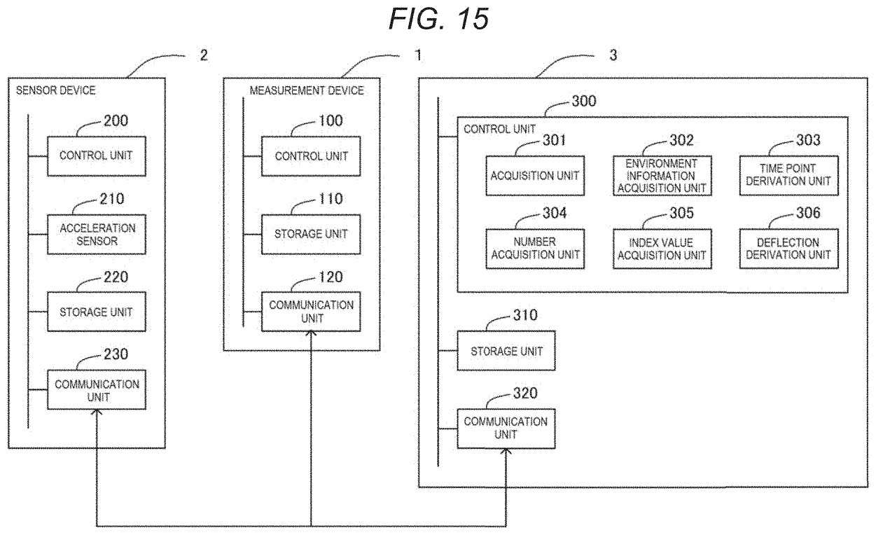

Here, each of the measurement device 1, the sensor device 2, and the server device 3 of the derivation system 10 will be described in detail with reference to FIG. 15.

In the present embodiment, the derivation system 10 derives the observation information (the number N of railway vehicles formed in the railway train 6, the time point tᵢ at which the railway train 6 enters the unit bridge girder, the time point tₒ at which the railway train 6 exits the unit bridge girder, and the period is during which the railway train 6 passes through the unit bridge girder) based on data measured by the measurement device 1.

The measurement device 1 measures the deflection at the observation point via the sensor device 2. In the present embodiment, the measurement device 1 is installed on the bridge abutment 8b, but may be installed at another position. The measurement device 1 includes a control unit 100, a storage unit 110, and a communication unit 120. The control unit 100 includes a processor such as a CPU (Central Processing Unit), a ROM (Read Only Memory), a RAM (Random Access Memory), and the like. The control unit 100 implements each function of the measurement device 1 by loading various programs recorded in the ROM or the like in the RAM and executing the programs via the CPU. The storage unit 110 stores various programs, measured deflection data, and the like. The communication unit 120 includes a circuit used for wired or wireless communication with an external device.

The sensor device 2 detects the acceleration as the predetermined physical quantity at the observation point. The sensor device 2 includes a control unit 200, an acceleration sensor 210, a storage unit 220, and a communication unit 230. The control unit 200 includes a processor such as a CPU, a ROM, a RAM, and the like. The control unit 200 implements each function of the sensor device 2 by loading various programs recorded in the ROM or the like in the RAM and executing the programs via the CPU.

The acceleration sensor 210 is an acceleration sensor such as a quartz acceleration sensor or a MEMS acceleration sensor capable of detecting an acceleration generated in each axial direction of three axes orthogonal to one another. In the present embodiment, the acceleration sensor 210 is disposed such that one axis is parallel to the vertical direction in order to more accurately detect the acceleration in the vertical direction. However, an installation location of the sensor device 2 in the superstructure 7 may be inclined. Even when one of the three detection axes of the acceleration sensor 210 is not installed in alignment with the vertical direction, the measurement device 1 combines the accelerations of the three axes and detects the acceleration in the vertical direction.

The control unit 200 of the sensor device 2 detects an acceleration in a cycle in the vertical direction at the observation point on the bridge 5 via the acceleration sensor 210, and transmits the detected acceleration data to the measurement device 1. The control unit 100 of the measurement device 1 measures the deflection of the bridge 5 in the vertical direction at the observation point at an acceleration detection time point based on the acceleration data transmitted from the sensor device 2. In the present embodiment, the control unit 100 obtains the deflection of the bridge 5 in the vertical direction at the observation point by integrating the acceleration indicated by the data transmitted from the sensor device 2 twice with respect to time. Then, the control unit 100 transmits the measured deflection data to the server device 3. In the present embodiment, the sensor device 2 detects the acceleration in a predetermined cycle ΔT. Therefore, the measurement device 1 measures time-series data of the deflection in the ΔT cycle. That is, the measured time-series data is data of discrete values of displacement measured in the ΔT cycle, and is data in which each discrete value is associated with the measurement time point.

The server device 3 derives the number of railway vehicles included in the railway train 6 based on the deflection of the observation point measured by the measurement device 1. The server device 3 is an example of a derivation device. The server device 3 includes a control unit 300, a storage unit 310, and a communication unit 320. The control unit 300 includes a processor such as a CPU, a ROM, a RAM, and the like. The control unit 300 implements functions of an acquisition unit 301, an environment information acquisition unit 302, a time point derivation unit 303, a number acquisition unit 304, an index value acquisition unit 305, and a deflection derivation unit 306 by loading various programs recorded in the ROM or the like into the RAM and executing the programs via the CPU. The storage unit 310 stores various programs, the detected deflection data, and the like. The communication unit 320 includes a circuit used for wired or wireless communication with an external device.

The acquisition unit 301 has a function of acquiring the time-series data of the deflection generated at the observation point as a response caused by the movement of the railway train 6 on each bridge in the bridge 5. With the function of the acquisition unit 301, the control unit 300 acquires the time-series data u(t) of the deflection generated at the observation point from the measurement device 1.

The environment information acquisition unit 302 has a function of acquiring environment information including information on the length of the unit bridge girder, the vehicle length that is the length of the railway vehicle formed in the railway train 6, and the position of the axle at which the wheel is installed in the railway vehicle. With the function of the environment information acquisition unit 302, the control unit 300 acquires, as the environment information, information on the bridge length L_{B} of the unit bridge girder, the vehicle length L_{c} of each railway vehicle of the railway train 6, and the distance Lₐ indicating the position of each railway vehicle of the railway train 6. In the present embodiment, the environment information is stored in advance in the storage unit 310, and the control unit 300 acquires the environment information from the storage unit 310. However, the control unit 300 may acquire the environment information by using another method such as receiving the environment information from an external device.

The time point derivation unit 303 has a function of deriving the entry time point tᵢ and the exit time point tₒ of the railway train 6 with respect to the unit bridge girder based on the time-series data u(t). The control unit 300 executes the FFT on u(t) with the function of the time point derivation unit 303. The control unit 300 detects peaks from the FFT result. The control unit 300 specifies, among the detected peaks, a peak corresponding to a minimum frequency excluding a peak of a side lobe generated due to an influence of a window function used in the FFT. The control unit 300 derives the frequency corresponding to the specified peak as the fundamental frequency F_{f} of u(t).

The control unit 300 applies low-pass filter processing for attenuating a component of a frequency equal to or higher than the fundamental frequency F_{f} to u(t) as follows. First, the control unit 300 derives the cycle T_{f} by deriving the reciprocal of F_{f} based on the acquired fundamental frequency F_{f} in the same manner as in Equation (35). The control unit 300 derives the interval k_{mf} using the following Equation (49) based on the derived T_{f} and ΔT which is a predetermined cycle.

$$\begin{matrix}{k}_{mf} = 2 ⌊ \frac{{T}_{f}}{2 Δ T} ⌋ + 1 & ( 49 )\end{matrix}$$

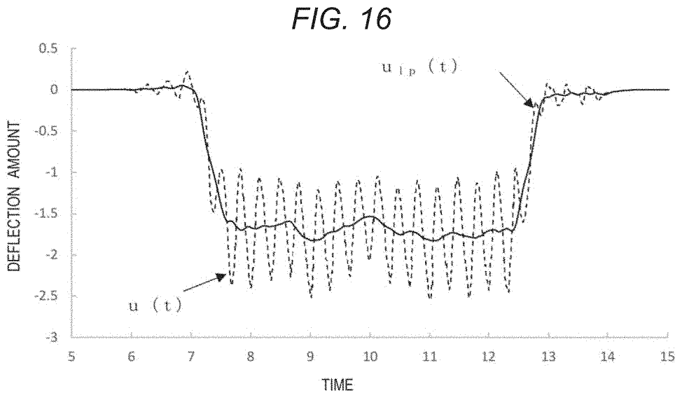

The control unit 300 applies a low-pass filter to u(t) by taking a moving average in the derived interval k_{mf} for each value of u(t). u(t) subjected to the low-pass filter processing is defined as u₁ₚ(t)=u₁ₚ(kΔT). Here, k is a variable indicating what number of observations when the deflection amount is observed in a cycle at the observation point. The control unit 300 derives u₁ₚ(t) using the following Equation (50) based on the derived interval k_{mf}. Similarly to u(t) which is data of a plurality of discrete values, u₁ₚ(t) is data of a plurality of discrete values. FIG. 16 shows the derived u₁ₚ(t). In a graph of FIG. 16, a horizontal axis represents time, and a vertical axis represents the deflection amount.

$${u}_{{l}_{p}} ( t ) = {u}_{{l}_{p}} ( k Δ T ) = \frac{1}{{k}_{mf}} {\sum }_{n = k - \frac{{k}_{mf} - 1}{2}}^{k + \frac{{k}_{mf} - 1}{2}} u ( n Δ T ) \qquad ( 50 )$$

Then, the control unit 300 specifies, from u₁ₚ(t), two consecutive pieces of data between which a predetermined threshold C_{L} related to the deflection amount is. Here, the fact that the threshold C_{L} is between the two consecutive pieces of data of u₁ₚ(t) means that CL is included in a range between the values of the two pieces of consecutively measured displacement data included in u₁ₚ(t), that is, a range from the smaller value of these displacement data to the larger value of these displacement data. In the present embodiment, it is assumed that the threshold C_{L} is a product of a predetermined coefficient from 0 to 1 and an average value of u₁ₚ(t) during a period during which the deflection amount is shifted. Here, the period during which the deflection amount is shifted is a period during which the deflection amount of the bridge is maintained within a predetermined range when the railway train riding on the bridge. More specifically, the period during which the deflection amount is shifted is a period during which the deflection amount falls within a range of a predetermined width centered on a value having an absolute value larger than a predetermined value. For example, the control unit 300 extracts data of the deflection amount during a period of a predetermined length (for example, 1 second, 2 seconds, or the like) from u₁ₚ(t), and determines the extracted period as the period during which the deflection amount is shifted when the absolute value of the average value of the extracted data is equal to or greater than a predetermined threshold and the absolute value of the difference between the maximum value and the minimum value of the extracted data is equal to or less than the predetermined width. The control unit 300 may receive designation of a start time point and an end time point of the period during which the deflection amount is shifted via an operation unit or the like of the server device 3. Then, the control unit 300 obtains an average value of u₁ₚ(t) for the period during which the deflection amount is shifted, and derives a product of the obtained average value and a predetermined coefficient as the threshold C_{L}.

However, the threshold C_{L} may be another value. For example, the threshold C_{L} may be a value of the deflection at the observation point of the bridge when the railway vehicle is disposed such that the wheel of first axle at the head of the railway vehicle is placed in the vicinity of the entry end. The threshold C_{L} may be a deflection amount at the observation point of the bridge when a predetermined weight is applied to the vicinity of the entry end. The threshold C_{L} may be a value of a predetermined ratio (for example, 10%, 1%, or the like) of the maximum value of the deflection amount at the observation point of the bridge when the railway train passes through the bridge.

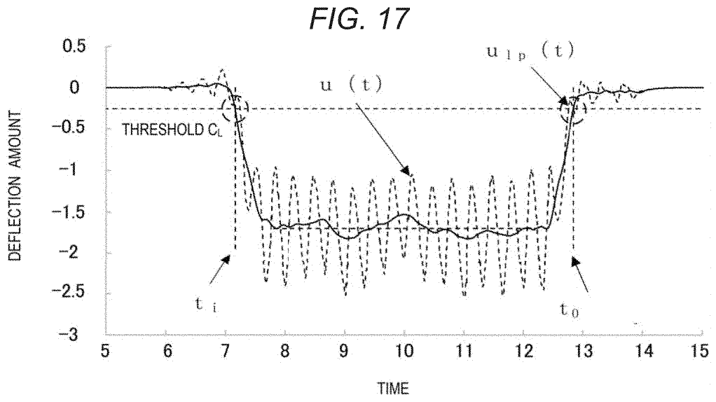

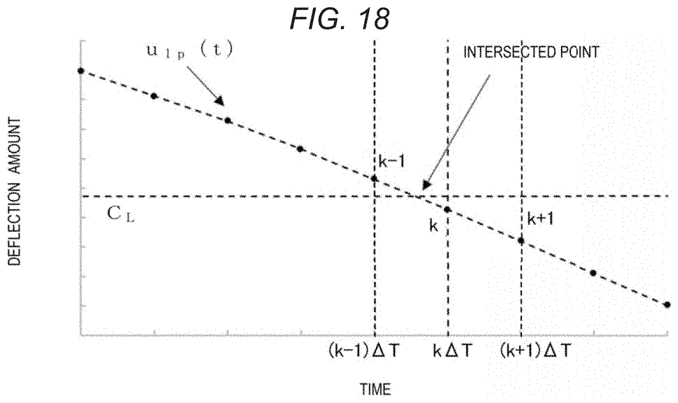

FIG. 17 shows u₁ₚ(t) and the threshold C_{L}. In a graph of FIG. 17, a horizontal axis represents time (t=kΔT), and a vertical axis represents the deflection amount. A solid line in the graph of FIG. 17 indicates u₁ₚ(t), and a dotted line in the graph indicates u(t). In portions surrounded by dotted circles in FIG. 17, u₁ₚ(t) and the threshold C_{L} intersect with each other. FIG. 18 shows an enlarged view of a portion where u₁ₚ(t) and CL intersect with each other (a portion of a dotted circle on the left side in the graph of FIG. 17). In a graph of FIG. 18, a horizontal axis represents time, and a vertical axis represents the deflection amount. Black dots in FIG. 18 indicate data of discrete values included in u₁ₚ(t). In an example of FIG. 18, the threshold C_{L} is between data k−1 included in u₁ₚ(t) and data k.

The control unit 300 specifies a later one of two time points corresponding to the two consecutive pieces of data between which the specified CL is. In the example of FIG. 18, the control unit 300 specifies a time point kΔT corresponding to the data k.

In an example of FIG. 17, the control unit 300 also specifies two pieces of data in a portion of a dotted circle on the right side in FIG. 17 as two consecutive pieces of data between which C_{L} is, and specifies the later one of two time points corresponding to the specified two pieces of data.

The control unit 300 derives the earlier one of the specified time points as the entry time point tᵢ of the railway train 6 entering into the unit bridge girder. In addition, the control unit 300 derives the later one of the specified time points as the exit time point tₒ of the railway train 6 exiting from the unit bridge girder. In the example of FIG. 17, the control unit 300 derives the entry time point tᵢ=7.2 [s] and the exit time point tₒ=12.795 [s]. As described above, in the present embodiment, the control unit 300 derives the time point associated with any data included in u₁ₚ(t) as the entry time point tᵢ and the exit time point tₒ.

As described above, in the present embodiment, the control unit 300 derives the later one of the two time points corresponding to the two consecutive pieces of data between which CL is, which are included in u₁ₚ(t), as the entry time point tᵢ and the exit time point tₒ. However, the control unit 300 may derive other time points as the entry time point tᵢ and the exit time point tₒ. For example, the control unit 300 may specify, from u₁ₚ(t), two consecutive pieces of data between which the predetermined threshold C_{L} related to the deflection amount is, and derive, as the entry time point tᵢ and the exit time point tₒ, a time point that is during a period after one time point of the time points corresponding to the two specified pieces of data and before the other time point. In the example of FIG. 18, the control unit 300 may derive, as the entry time point tᵢ, a time point after a time point (k−1)ΔT corresponding to the data k−1 and before the time point kΔT corresponding to the data k (for example, time point (k−1)ΔT, a time point corresponding to a point where u₁ₚ(t) and CL intersect with each other). In addition, the control unit 300 may obtain a curve obtained by interpolating data included in u₁ₚ(t), and obtain time points corresponding to intersection points of the obtained curve and CL as t₁ and to.

It is conceivable that one of two consecutive pieces of data between which CL included in u₁ₚ(t) is present is equal to CL. For example, in the example of FIG. 18, the value of the data k may be equal to CL. In this case, the control unit 300 specifies two sets of data, that is, a set of data equal to CL and data preceding the data and a set of data equal to CL and data following the data, as two consecutive pieces of data between which CL is. In the example of FIG. 18, when the data k is equal to CL, the control unit 300 specifies two sets of a set of the data k−1 and the data k and a set of the data k and data k+1 as two consecutive pieces of data between which CL is. In such a case, the control unit 300 may select any one set of the specified sets of data and derive a time point between two time points corresponding to two pieces of data included in the selected set as tᵢ or tₒ.

In the present embodiment, the control unit 300 derives the time point associated with any data included in u₁ₚ(t) as the entry time point tᵢ and the exit time point tₒ. As a result, the control unit 300 can easily acquire and utilize the data of u₁ₚ(t) corresponding to each measurement time point of ΔT interval including the entry time point tᵢ and the exit time point tₒ by referring to u₁ₚ(t). On the other hand, when deriving the time point not associated with any data included in u₁ₚ(t) as the entry time point tᵢ and the exit time point tₒ, the control unit 300 obtains the data of u₁ₚ(t) corresponding to each measurement time point of the ΔT interval including tᵢ and tₒ by resampling from the original u₁ₚ(t) or the like, which increases time and effort of processing.

The control unit 300 derives the entry time point and the exit time point by using u₁ₚ(t) in which a vibration component of a frequency equal to or higher than the fundamental frequency is attenuated, thereby reducing an influence of the vibration component of a frequency equal to or higher than the fundamental frequency and more accurately deriving the entry time point and the exit time point.

However, the control unit 300 may not derive u₁ₚ(t). In this case, the control unit 300 may derive time points at which u(t) and the threshold C_{L} intersect with each other as tᵢ and tₒ, for example.

The number acquisition unit 304 has a function of acquiring the number of railway vehicles formed in the railway train 6. The control unit 300 derives the number of railway vehicles included in the railway train 6 based on the first feature by the function of the number acquisition unit 304. Based on tᵢ and tₒ, the control unit 300 derives the passing period is during which the railway train 6 passes through the unit bridge girder using Equation (1). Then, the control unit 300 derives the wave number ν of the fundamental frequency F_{f} included in the passing period tₛ using Equation (33) based on the derived tₛ and the fundamental frequency F_{f} derived based on u(t). Based on the derived ν, the control unit 300 derives the number N of railway vehicles included in the railway train 6 using Equation (34), thereby acquiring N. As described above, the control unit 300 derives, as the value of N, a value obtained by subtracting one from the product of tₛ and the fundamental frequency F_{f} of u(t) and rounding the product to an integer.

However, the control unit 300 may acquire N by another method. For example, the control unit 300 may be configured as follows based on the second feature. That is, the control unit 300 subtracts u₁ₚ(t) from u(t) to execute high-pass filter processing for attenuating a component of a frequency lower than the fundamental frequency on u(t), and derive uₕₚ(t) which is u(t) on which the high-pass filter processing was performed. Then, the control unit 300 specifies the number of positive peaks from the data of the period from tᵢ to tₒ in uₕₚ(t). The control unit 300 may acquire N by deriving a value obtained by subtracting two from the specified number of positive peaks as the value of N.

In addition, the control unit 300 specifies the number of negative peaks from the data of the period from tᵢ to tₒ in uₕₚ(t). The control unit 300 may acquire N by deriving a value obtained by subtracting one from the specified number of negative peaks as the value of N.

In addition, the control unit 300 may use a method conceived by the inventors as follows. That is, the control unit 300 derives the average velocity vₐ of the railway train using Equation (47) based on the fundamental frequency F_{f} and the vehicle length L_{c}(m) of the railway vehicles of the railway train 6 indicated by the environment information. Based on the derived vₐ and L_{B} and Lₐ that are indicated by the environment information, the control unit 300 derives the period t_{c}(m) during which one railway vehicle passes through the bridge using Equation (40). Then, based on the derived F_{f}, tₛ, and t_{c}(m), the control unit 300 may derive the number N of railway vehicles formed in the railway train 6 using Equation (48) and acquire N.

However, the control unit 300 may not derive the value of N. For example, the control unit 300 may receive the designation of N based on the operation of the operation unit of the server device 3 executed by a user and acquire the received value as N. In addition, the control unit 300 may receive designation of N from an external device and acquire the received value as N. Further, the control unit 300 may acquire a predetermined value as N.

The index value acquisition unit 305 has a function of deriving a first index value, which is an index value of the deflection amount of the structure generated at the observation point, and a second index value, which is an index value of the deflection amount of the structure at the designated position 9, based on the number N of railway vehicles formed in the railway train 6, the entry time point tᵢ, the exit time point tₒ, and the environment information. In the present embodiment, the position of the designated position 9 in the unit bridge girder is the position of the distance L_{B}×rx from the entry end to the exit end. Here, rx is a value indicating a ratio of the distance from the entry end of the unit bridge girder to the designated position 9 to L_{B}. In the present embodiment, rx is 0.05.

With the function of the index value acquisition unit 305, the control unit 300 derives, as a first index value that is an index value of the deflection amount at the observation point, an estimated value of a normalized deflection amount generated at the observation point due to the passage of the railway train 6 when N railway vehicles are formed in the railway train 6. Specifically, the control unit 300 derives tₛ from tᵢ and tₒ using Equation (1). The control unit 300 derives vₐ from tₛ, N, aᵣ, Lₐ, L_{B}, and L_{c} using Equation (5). That is, vₐ is derived as a value obtained by dividing the sum of the distance from the foremost axle (the first axle of the foremost railway vehicle) to the rearmost axle (the aᵣ(N)th axle of the rearmost railway vehicle) in the railway train formed with N railway vehicles and the bridge length L_{B} by the passing period tₛ which is a period from the entry time point tᵢ to the exit time point tₒ. The control unit 300 derives tₓₙ and tₗₙ from vₐ, L_{B}, and Lₓ using Equation (22) and Equation (23). In addition, the control unit 300 derives tₒ(m, n) from Lₐ, L_{c}, and tᵢ using Equation (3) and Equation (24). Then, the control unit 300 derives the function w_{std}(a_{w}(m, n), t) for each axle of each railway vehicle of the railway train 6 by substituting the derived tₓₙ, tₗₙ, and tₒ(m, n) into Equation (29) and Equation (30).

The control unit 300 adds up w_{std}(a_{w}(m, n), t) for the axles for N railway vehicles of the railway train 6 using Equation (31), thereby deriving C_{std}(m, t) indicating the deflection of the unit bridge girder due to the passage of the railway vehicles. Then, the control unit 300 derives T_{std}(t) as the deflection of the unit bridge girder due to the passage of the railway train by adding up C_{std}(m, t) of the N railway vehicles using Equation (32). In this way, the control unit 300 acquires the normalized deflection amount T_{std}(t) at the observation point as the first index value. Hereinafter, T_{std}(t) acquired as the first index value is referred to as T_{std_R} (t).

The control unit 300 derives, as a second index value that is an index value of the deflection amount at the designated position 9, a normalized estimated value of the deflection amount generated at the designated position 9 due to the passage of the railway train 6 when N railway vehicles are formed in the railway train 6. Specifically, the control unit 300 replaces Lₓ with L_{B}×rx from vₐ, L_{B}, and rx, and derives tₓₙ and tₗₙ using Equation (22) and Equation (23). In addition, the control unit 300 derives tₒ(m, n) from Lₐ, L_{c}, and tᵢ using Equation (3) and Equation (24). Then, the control unit 300 derives the function w_{std}(a_{w}(m, n), t) for each axis of each railway vehicle of the railway train 6 by substituting the derived tₓₙ, tₗₙ, tₒ (m, n) into Equation (29) and Equation (30).

The control unit 300 adds w_{std}(a_{w}(m, n), t) for the axles for N railway vehicles of the railway train 6 using Equation (31), thereby deriving C_{std} (m, t) indicating deflection of the unit bridge girder due to the passage of the railway vehicles. Then, the control unit 300 derives T_{std}(t) as the deflection of the unit bridge girder due to the passage of the railway train by adding up C_{std}(m, t) of the N railway vehicles using Equation (32). In this way, the control unit 300 acquires the normalized deflection amount T_{std}(t) at the designated position 9 as the second index value. Hereinafter, T_{std}(t) acquired as the second index value is referred to as T_{std_rx}(t).

The deflection derivation unit 306 has a function of deriving the estimated value of the deflection amount of the unit bridge girder at the designated position 9 based on the time-series data u(t), the first index value T_{std_R}(t), and the second index value T_{std_rx}(t).

With the function of the deflection derivation unit 306, the control unit 300 specifies, as a period from when deflection starts to when the deflection converges, a period from a time point t1 at which the deflection starts and the value of the deflection amount becomes larger than 0 to a time point t2 at which the deflection converges and the value of the deflection amount converges to 0, in T_{std_R}(t) and T_{std_rx}(t).

In addition, the control unit 300 derives a ratio R_{rx_R}(t) of a predetermined amount corresponding to the first index value T_{std_R}(t) to a predetermined amount corresponding to the second index value T_{std_rx}(t). In the present embodiment, the predetermined amount corresponding to the first index value T_{std_R}(t) is the first index value T_{std_R}(t). The predetermined amount corresponding to the second index value T_{std_rx} (t) is the second index value T_{std_rx}(t). Therefore, in the present embodiment, the control unit 300 derives a ratio R_{rx_R}(t) of the first index value T_{std_R}(t) to the second index value T_{std_rx}(t) using the following Equation (51). However, as another example, the predetermined amount corresponding to the first index value T_{std_R}(t) may be an amount obtained by attenuating a component of a frequency equal to or higher than the fundamental frequency of the first index value T_{std_R}(t) from the first index value T_{std_R}(t). The predetermined amount corresponding to the second index value T_{std_rx}(t) may be an amount obtained by attenuating a component of a frequency equal to or higher than the fundamental frequency of the second index value T_{std_R}(t) from the second index value T_{std_R}(t). The control unit 300 may derive, as the ratio R_{rx_R}(t), a value obtained by dividing an amount obtained by attenuating a component of a frequency equal to or higher than the fundamental frequency of the second index value T_{std_R}(t) from the second index value T_{std_R}(t) by an amount obtained by attenuating a component of a frequency equal to or higher than the fundamental frequency of the first index value T_{std_R}(t) from the first index value T_{std_R}(t).

$${R}_{rx\_R} ( t ) = \frac{{T}_{std\_rx} ( t )}{{T}_{std\_R} ( t )} \qquad ( 51 )$$

Based on t₁, t₂, and R_{rx_R}(t), the control unit 300 derives an average value Ravg of the ratio of the first index value T_{std_R}(t) to the second index value T_{std_rx}(t) in the period from the time point tᵢ to the time point t₂ using the following Equation (52).

$$Ravg = \frac{1}{{t}_{2} - {t}_{1}} {\sum }_{t = {t}_{1}}^{{t}_{2}} {R}_{rx\_R} ( t ) \qquad ( 52 )$$

However, the control unit 300 may derive, as Ravg, an average value of ratios of T_{std_R}(t) and T_{std_rx}(t) in a period different from the period from the time point tᵢ to the time point t₂. For example, the control unit 300 may derive, as Ravg, an average value of ratios of T_{std_R}(t) and T_{std_rx}(t) in the passing period tₛ. In this case, the control unit 300 may derive Ravg using Equation (52) by replacing t₁ and t₂ in Equation (52) with tᵢ and tₒ.

Then, the control unit 300 derives, as an estimated value of the deflection amount at the designated position 9, a value obtained by multiplying the time-series data u(t) by Ravg. However, the control unit 300 may derive the estimated value of the deflection amount at the designated position 9 by multiplying each piece of data included in the time-series data u(t) by the corresponding R_{rx_R}(t).

As described above, according to the configuration of the present embodiment, the derivation system 10 can derive the deflection amount of the unit bridge girder at the designated position 9 different from the observation point.

### (1-2) Derivation Processing

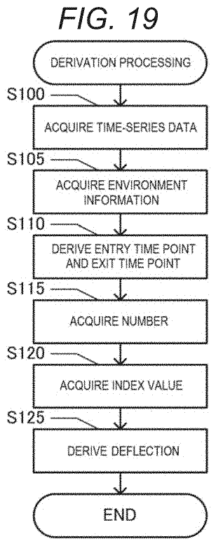

Processing of deriving the deflection amount at the designated position 9 executed by the server device 3 will be described with reference to FIG. 19. The server device 3 starts processing in FIG. 19 in response to the fact that the data of the displacement at the observation point is transmitted from the measurement device 1, but may start the processing in FIG. 19 at any timing such as a designated timing.

In S100, the control unit 300 acquires the time-series data u(t) of the deflection generated at the observation point from the measurement device 1 by the function of the acquisition unit 301. S100 is an example of an acquisition step.

In S105, with the function of the environment information acquisition unit 302, the control unit 300 acquires information on the bridge length L_{B} of the unit bridge girder, the vehicle length L_{c} of each railway vehicle of the railway train 6, and the distance Lₐ indicating the position of each railway vehicle of the railway train 6 as the environment information. S105 is an example of an environment information acquisition step.

In S110, with the function of the time point derivation unit 303, the control unit 300 executes the FFT on u(t) and detects peaks from the FFT result. The control unit 300 specifies, among the detected peaks, a peak corresponding to a minimum frequency excluding a peak of a side lobe generated due to an influence of a window function used in the FFT. The control unit 300 derives the frequency corresponding to the specified peak as the fundamental frequency F_{f} of u(t). The control unit 300 derives the cycle T_{f} by deriving the reciprocal of F_{f} based on the acquired fundamental frequency F_{f} in the same manner as in Equation (35). The control unit 300 derives the interval k_{mf} using Equation (49) based on the derived T_{f} and ΔT which is a predetermined cycle. The control unit 300 derives u₁ₚ(t) using Equation (50) based on the derived interval k_{mf}.

In addition, the control unit 300 extracts an interval having a predetermined value (for example, 1 second, seconds, or the like) from u₁ₚ(t), and when the absolute value of the difference between the maximum value and the minimum value of the deflection amount in the extracted interval is equal to or less than a predetermined threshold, the control unit 300 determines an interval in which the deflection amount is shifted in the extracted interval. The control unit 300 obtains an average value of u₁ₚ(t) for the interval in which the deflection amount is shifted, and derives a product of the obtained average value and a predetermined coefficient as the threshold C_{L}.

Then, the control unit 300 obtains an intersection point of u₁ₚ(t) and the derived threshold C_{L}. Specifically, the control unit 300 obtains two values of t that satisfy u₁ₚ(t)=CL. Then, the control unit 300 derives the time point indicated by the smaller one of the obtained values of t as the entry time point tᵢ of the railway train 6 entering into the unit bridge girder. In addition, the control unit 300 derives the time point indicated by the larger one of the obtained values of t as the exit time point tₒ of the railway train 6 exiting from the unit bridge girder. S110 is an example of a time point derivation step.

In S115, with the function of the number acquisition unit 304, the control unit 300 derives the passing period to during which the railway train 6 passes through the unit bridge girder using Equation (1) based on tᵢ and tₒ derived in S110. Then, the control unit 300 derives the wave number ν of the fundamental frequency F_{f} included in the passing period to using Equation (33) based on F_{f} derived in S110 and the derived to. Based on the derived ν, the control unit 300 derives the number N of railway vehicles included in the railway train 6 using Equation (34), thereby acquiring N. S115 is an example of a number acquisition step.

In S120, with the function of the index value acquisition unit 305, the control unit 300 derives vₐ from tₒ, N, aᵣ, Lₐ, and L_{c} using Equation (5). The control unit 300 derives tₓₙ and tₗₙ from vₐ, L_{B}, and Lₓ using Equation (22) and Equation (23). In addition, the control unit 300 derives tₒ(m, n) from Lₐ, L_{c}, and t₁ using Equation(3) and Equation (24). Then, the control unit 300 derives the function w_{std}(a_{w}(m, n), t) for each axis of each railway vehicle of the railway train by substituting the derived tₓₙ, tₗₙ, and tₒ(m, n) into Equation (29) and Equation (30).

The control unit 300 adds w_{std}(a_{w}(m, n), t) for the axles for N railway vehicles of the railway train 6 using Equation (31), thereby deriving C_{std}(m, t) indicating deflection of the unit bridge girder due to the passage of the railway vehicles. Then, the control unit 300 acquires, as the first index value T_{std_R}(t) the normalized deflection amount T_{std}(t) of the unit bridge girder due to the passage of the railway train by adding up C_{std}(m, t) of the N railway vehicles using Equation (32).

In addition, the control unit 300 replaces Lₓ with L_{B}×rx from vₐ, L_{B}, and rx, and derives tₓₙ and tₗₙ using Equation (22) and Equation (23). Further, the control unit 300 derives tₒ(m, n) from Lₐ, L_{c}, and t₁ using Equation (3) and Equation (24). Then, the control unit 300 derives the function w_{std}(a_{w}(m, n), t) for each axis of each railway vehicle of the railway train 6 by substituting the derived tₓₙ, tₗₙ, and tₒ(m, n) into Equation (29) and Equation (30).

The control unit 300 adds up w_{std}(a_{w}(m, n), t) for the axles for N railway vehicles of the railway train 6 using Equation (31), thereby deriving C_{std}(m, t) indicating deflection of the unit bridge girder due to the passage of the railway vehicles. Then, the control unit 300 derives T_{std}(t) as the deflection of the unit bridge girder due to the passage of the railway train by adding up C_{std}(m, t) of the N railway vehicles using Equation (32). In this way, the control unit 300 acquires the normalized deflection amount T_{std}(t) at the designated position 9 as the second index value T_{std_rx}(t). S120 is an example of an index value acquisition step.

In S125, with the function of the deflection derivation unit 306, the control unit 300 specifies, as a period from when the deflection starts to when the deflection converges, a period from the time point tᵢ at which the deflection starts and the value of the deflection amount becomes larger than 0 to the time point t₂ at which the deflection converges and the value of the deflection amount converges to 0, in T_{std_R}(t) and T_{std_rx}(t). Then, the control unit 300 derives the ratio R_{rx_R}(t) of the first index value T_{std_R}(t) to the second index value T_{std_rx}(t) using Equation (51). Based on t₁, t₂, and R_{rx_R}(t), the control unit 300 derives the average value Ravg of the ratio of the first index value T_{std_R} (t) to the second index value T_{std_rx}(t) in the period from the time point tᵢ to the time point t₂ using Equation (52). The control unit 300 derives, as the estimated value of the deflection amount at the designated position 9, the value obtained by multiplying the time-series data u(t) by Ravg. S125 is an example of a deflection derivation step.

### (2) Second Embodiment

### (2-1) Configuration of Derivation System

### (2-1-1) Outline of Derivation System

The derivation system 10 of the present embodiment has the same configuration as that of the first embodiment. However, processing of the server device 3 is different from that of the first embodiment.

### (2-1-2) Verification Experiment

The inventors conceived that the actual deflection amount T (t) at a certain position in the bridge is approximated by the sum of the deflection amount proportional to the deflection amount T_{std}(t) at that position derived by the deflection model and the T_{offset}(t) that is not correlated with the deflection amount derived by the deflection model. That is, the inventors conceived an idea of approximating T(t) as a linear function for T_{std}(t) as in the following Equation (53). c₁ in Equation (53) is a linear coefficient. Here, a portion proportional to the deflection amount derived by the deflection model is a displacement proportional to the load of the unit bridge girder to which the BWIM can be applied.

T(t)=c₁T_{std}(t)+T_{offset}(t) (53)

The inventors conceived that u₁ₚ(t) obtained by subjecting the time-series data measured at the observation point to the low-pass filter processing is approximated as a linear function in which T_{std_R_1p}(t) obtained by subjecting the normalized deflection amount T_{std_R}(t) of the observation point derived using the deflection model to the low-pass filter processing for attenuating a component of a frequency equal to or higher than a fundamental frequency is a variable and in which the linear coefficient is c₁, as shown in the following Equation (54). C₀ in Equation (54) is a zero-order coefficient and indicates a displacement independent of a position on the bridge. Here, during the period from the entry time point tᵢ to the exit time point tₒ, u₁ₚ(t) is approximated as a linear function for T_{std_1p}(t).

u₁ₚ(t)=c₁T_{std_R_1p}(t)+c₀tᵢ≤t≤tₒ (54)

When a value obtained by subtracting the right side from the left side of Equation (54) is used as an error, and c₁ and c₀ are derived by using a least-squares method so as to minimize the error, the following Equation (55) and Equation (56) are obtained.

$${c}_{1} = \frac{K {\sum }_{t = {t}_{a}}^{{t}_{b}} {u}_{{l}_{p}} ( t ) {T}_{std\_R \_lp} ( t ) - {\sum }_{t = {t}_{a}}^{{t}_{b}} {T}_{std\_R \_lp} ( t ) {\sum }_{t = {t}_{a}}^{{t}_{b}} {u}_{{l}_{p}} ( t )}{K {\sum }_{t = {t}_{a}}^{{t}_{b}} {{T}_{std\_R \_lp} ( t )}^{2} - {\sum }_{t = {t}_{a}}^{{t}_{b}} {{T}_{std\_R \_lp} ( t )}^{2}} \qquad ( 55 )$$

$${c}_{0} = \frac{{\sum }_{t = {t}_{a}}^{{t}_{b}} {u}_{{l}_{p}} ( t ) - {\sum }_{t = {t}_{a}}^{{t}_{b}} {T}_{std\_R \_lp} ( t )}{K} \qquad ( 56 )$$

In Equation (55) and Equation (56), to is a start time point of a predetermined period of time for which u₁ₚ(t) is approximated by T_{std_R_1p}(t). In the present embodiment, to is the entry time point tᵢ. In addition, t_{b} is an end time point of the predetermined period of time for which u₁ₚ(t) is approximated by T_{std_R_1p}(t). In the present embodiment, t_{b} is the exit time point tₒ. K in Equation (55) and Equation (56) is a value represented by the following Equation (57).

$$k = {\sum }_{t = {t}_{a}}^{{t}_{b}} 1 \qquad ( 57 )$$

As shown on the right side of Equation (54), the deflection amount restored using T_{std_R_1p}(t) and the coefficients c₁ and c₀ is defined as T_{Estd_R_1p}(t). T_{Estd_R_1p}(t) is represented by the following Equation (58). Here, in the periods of t<tᵢ and t>tₒ, since the railway train does not travel on the bridge, it is defined that there is no deflection, and c₀=0.

$${T}_{E std\_R \_lp} ( t ) = \{ \begin{matrix}t < {t}_{i} : & {c}_{1} {T}_{std\_R \_lp} ( t ) \\ {t}_{i} \leq t \leq {t}_{o} : & {c}_{2} {T}_{std\_R \_lp} ( t ) + {c}_{0} \\ {t}_{0} < t : & {c}_{1} {T}_{std\_R \_lp} ( t )\end{matrix} \qquad ( 58 )$$

An amplitude ratio Rr of T_{Estd_R_1p}(t) to T_{std_R_1p}(t) is obtained by the following Equation (59). k₀ in Equation (59) is a value indicating what number of observations of the deflection amount performed earliest during the period during which the waveform of the deflection amount u₁ₚ(t) is shifted. N is a value obtained by subtracting k₀ from a value indicating what number of observations of the deflection amount, which is performed latest during the period during which the waveform of the deflection amount u₁ₚ(t) is shifted. That is, the observation of the deflection amount performed latest during the period during which the waveform of u₁ₚ(t) is shifted is the (k₀+N)th observation.

$${R}_{r} = ( \frac{1}{n + 1} {\sum }_{k = {k}_{0}}^{{k}_{0} + n} {T}_{E std\_R \_lp} ( k Δ T ) ) / ( \frac{1}{n + 1} {\sum }_{k = {k}_{0}}^{{k}_{0} + n} {T}_{std\_R \_lp} ( k Δ T ) ) \qquad ( 59 )$$

The inventors assumed that the offset T_{offset_R_std}(t) at the observation point is a product of Rr and T_{std_R_1p}(t) and is a value rounded to c₀ for an element having an absolute value larger than c₀, as shown in the following Equation (60). That is, T_{offset_R_std}(t) indicates a component of deflection that the value approaches c₀ with the passage of time from the entry of the railway train into the bridge, remains constant at c₀ after the value reached c₀, and converges to 0 with the passage of time when the railway train exits.

$${T}_{offset\_R \_std} ( t ) = \{ \begin{matrix}\vert {R}_{r} {T}_{std\_R \_lp} ( t ) \vert \leq \vert {c}_{0} \vert : & {R}_{r} {T}_{std\_R \_lp} ( t ) \\ \vert {R}_{r} {T}_{std\_R \_lp} ( t ) \vert \leq \vert {c}_{0} \vert : & {c}_{0}\end{matrix} \qquad ( 60 )$$

The estimated value of the deflection amount at the observation point is defined as T_{EO_R}(t). From a relationship represented by Equation (54), the inventors considered that T_{EO_R}(t) is represented as the sum of T_{offset_R_std}(t) and the product of c₁ and the estimated value T_{std_R}(t) using the deflection model, as in the following Equation (61).

T_{EO_R}(t)=C₁T_{std_R}(t)+T_{offset_R_std}(t) (61)

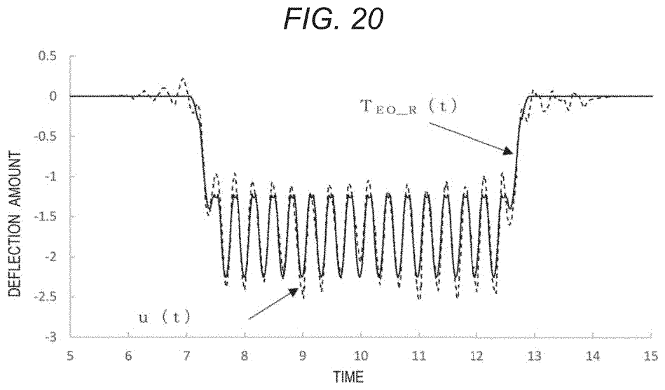

FIG. 20 shows the time-series data u(t) of the deflection amount actually measured at the observation point of the bridge, and the estimated value T_{E_OR}(t) of the deflection amount at the observation point derived from the normalized deflection amount T_{std_R}(t) at the observation point derived from the deflection model by Equation (61). In a graph of FIG. 20, a horizontal axis represents time, and a vertical axis represents the deflection amount. A solid line in the graph of FIG. 20 indicates T_{EO_R}(t). A dotted line in the graph indicates u(t). It was confirmed from FIG. 20 that the estimated value T_{E_OR}(t) accurately restores u(t).

From this, the inventors conceived the following method for deriving the deflection amount at a designated position.

Here, it is assumed that a position of a distance L_{B}rₓ from the entry end to the exit end on the bridge is designated as the position for deriving the deflection amount. Here, it is assumed that rₓ=0.05. Here, the normalized deflection amount at the designated position derived using the deflection model is defined as T_{std_rx}(t). T_{std_rx}(t) subjected to the low-pass filter processing for attenuating a component of a frequency equal to or higher than the fundamental frequency is defined as T_{std_rx_1p}(t).

That is, assuming that the deflection amount T_{Estd_rx_1p}(t) is restored by adding c₀ to the product of T_{std_rx_1p}(t) and the coefficient c₁, the inventors conceived a method of deriving the deflection amount at a designated position by obtaining an amplitude ratio of T_{Estd_rx_1p}(t) to T_{std_rx_1p}(t) in the same manner as in Equation (59) using T_{std_rx_1p}(t) and the coefficients c₁ and c₀, obtaining an offset in the same manner as in Equation (60) from the obtained amplitude ratio and T_{std_rx_1p}(t), and adding an obtained offset to the product of T_{std_rx}(t) and c₁ in the same manner as in Equation (61).

Hereinafter, a procedure of this method performed by the inventors will be described.

The inventors obtained T_{std_rx}(t), and obtained T_{std_rx_1p}(t) by subjecting the obtained T_{std_rx}(t) to the low-pass filter processing for attenuating a component of a frequency equal to or higher than the fundamental frequency.

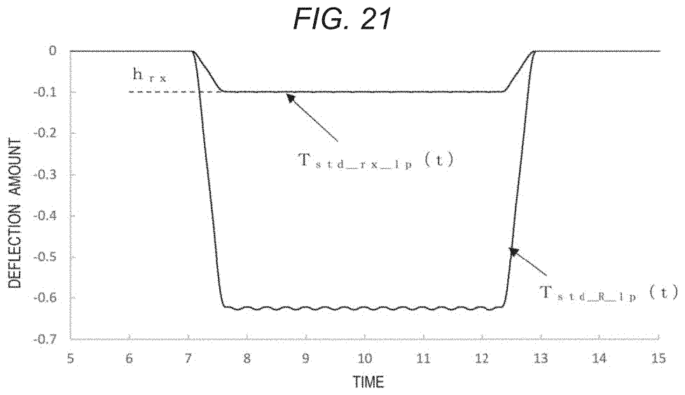

The inventors then derived an amplitude hᵣₓ of T_{std_rx_1p} (t) using the following Equation (62). FIG. 21 shows the derived amplitude hᵣₓ.

$${h}_{rx} = \frac{1}{{t}_{2} - {t}_{1}} {\sum }_{t = {t}_{1}}^{{t}_{2}} {T}_{std\_rx \_lp} ( t ) \qquad ( 62 )$$

In Equation (62), t₁ and t₂ are respectively a start time point and an end time point of any period during a period during which vibration due to the passage of the railway train is generated in the bridge. In the present embodiment, t₁ and t₂ are respectively a start time point and an end time point of a period set within a period during which T_{std_rx_1p}(t) is shifted. That is, t₁ and t₂ are periods during which the value of T_{std_rx_1p}(t) falls within a range of a predetermined width centered on a value whose absolute value is larger than a predetermined value. For example, t₁ and t₂ may be respectively a start time point and an end time point of a period having a predetermined width (for example, 1 second, 2 seconds, or the like) in the center of the passing period tₛ (the period from the entry time point tᵢ to the exit time point to). In addition, t₁ and t₂ may be respectively a time point after a lapse of a predetermined period (for example, a period having a length of a predetermined ratio (10%, 30%, or the like) of the passing period tₛ) from the entry time point tᵢ and a time point earlier than the exit time point tₒ by a predetermined period (for example, a period having a length of a predetermined ratio (10%, 30%, or the like) of the passing period tₛ).

In this way, the inventors derived the average value of T_{std_rx_1p}(t) in the period from t₁ to t₂ as the amplitude hᵣₓ using Equation (62).

The inventors derived the coefficients c₁ and c₀ by using Equation (55) and Equation (56) based on u₁ₚ(t) obtained by subjecting the time-series data u(t) to the low-pass filter processing for attenuating a component of a frequency equal to or higher than the fundamental frequency and T_{std_R_1p}(t) obtained by subjecting the normalized deflection amount estimated value T_{std_R}(t) at the observation point derived by using the deflection model to the low-pass filter processing for attenuating a component of a frequency equal to or higher than the fundamental frequency.

The amplitude of T_{Estd_rx_1p}(t) will be discussed. T_{Estd_rx_1p} (t) is a value obtained by substituting T_{std_rx_1p} (t) instead of T_{std_R_1p}(t), that is, a value obtained by adding c₀ to the product of T_{std_rx_1p}(t) and the coefficient c₁, as an argument in the linear function shown in Equation (53). Therefore, a time function R_{r_rx}(t) indicating the amplitude ratio of T_{Estd_rx_1p}(t) to T_{std_rx_1p}(t) is represented by the following Equation (63).

$${R}_{r\_rx} ( t ) = \frac{{T}_{E std\_rx \_lp} ( t )}{{T}_{std\_rx \_lp} ( t )} = \frac{{c}_{1} {T}_{std\_rx \_lp} ( t ) + {c}_{0}}{{T}_{std\_rx \_lp} ( t )} \qquad ( 63 )$$

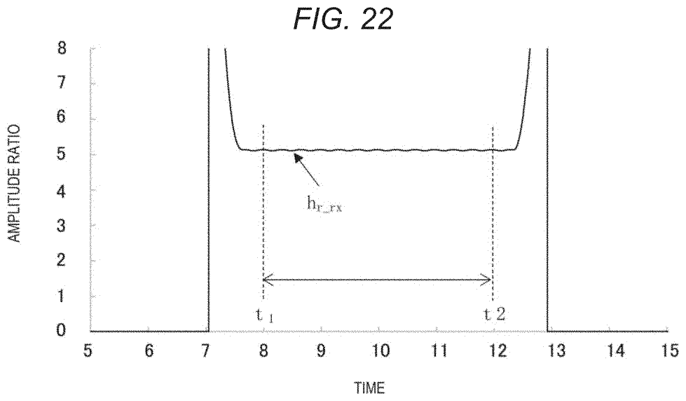

The function R_{r_rx}(t) is shown in FIG. 22. Here, since T_{std_rx_1p}(t) is shifted during the period from t₁ to t₂, the denominator and numerator of the right side of Equation (63) are substantially constant values during the period from t₁ to t₂, and the value of R_{r_rx}(t) is also substantially constant. That is, the period from t₁ to t₂ is a period during which the value of the amplitude ratio at each time point indicated by R_{r_rx}(t) falls within a range of a predetermined width centered on a value whose absolute value is equal to or greater than a predetermined value. Here, the average amplitude ratio of R_{r_rx}(t) in the period from t₁ to t₂ is defined as R_{r_rx}. The amplitude ratio R_{r_rx} is represented by the following Equation (64).

$${R}_{r\_rx} ( t ) = \frac{1}{{t}_{2} - {t}_{1}} {\sum }_{t = {t}_{1}}^{{t}_{2}} {R}_{r\_rx} ( t ) \qquad ( 64 )$$

The amplitude of T_{Estd_rx_1p}(t) is a value obtained by adding c₀ to the product of the amplitude hᵣₓ of T_{std_rx_1p}(t) and c₁. Therefore, the amplitude ratio R_{r_rx} is also represented as a ratio of the amplitude of T_{Estd_rx_1p}(t) to the amplitude hᵣₓ of T_{std_rx_1p} (t) by the following Equation (65).

$${R}_{r\_rx} = \frac{{c}_{1} {h}_{rx} + {c}_{0}}{{h}_{rx}} \qquad ( 65 )$$

The inventors derived the amplitude ratio R_{r_rx} using Equation (64) based on t₁, t₂, and R_{r_rx}(t). However, the amplitude ratio R_{r_rx} can also be derived by using Equation (65) based on hᵣₓ, c₁, and c₀. Then, the inventors derived the deflection amount T_{r_rx} obtained by multiplying T_{std_rx_1p} (t) by R_{r_rx} using the following Equation (66).

T_{r_rx}(t)=T_{std_rx_1p}(t)R_{r_rx} (66)

The deflection amount T_{r_rx} can be derived using the following Equation (67) derived by replacing R_{r_rx} of Equation (66) with a ratio of T_{Estd_rx_1p} (t) (a value obtained by adding c₀ to a product of T_{std_rx_1p}(t) and the coefficient c₁) to T_{std_rx_1p} (t).

T_{r_rx}(t)=C₁T_{std_rx_1p}(t)+c₀ (67)

When c₀=0 before the entry time point tᵢ and after the exit time point tₒ, T_{r_rx} may be represented by the following Equation (68).

$${T}_{r\_rx} ( t ) = \{ \begin{matrix}t < {t}_{i} : & {c}_{1} {T}_{std\_rx \_lp} ( t ) \\ {t}_{i} \leq t \leq {t}_{o} : & {c}_{2} {T}_{std\_rx \_lp} ( t ) + {c}_{0} \\ {t}_{0} < t : & {c}_{1} {T}_{std\_rx \_lp} ( t )\end{matrix} \qquad ( 68 )$$

Then, the inventors derived the offset T_{offset_rx}(t) of the deflection amount at the designated position based on the derived T_{r_rx} using Equation (69). That is, the inventors derived T_{r_rx} obtained by rounding an element whose absolute value is larger than c₀ to c₀ as T_{offset} rₓ (t).

$${T}_{offset\_rx} ( t ) = \{ \begin{matrix}\vert {T}_{r\_rx} ( t ) \vert > \vert {c}_{0} \vert : & {c}_{0} \\ \vert {T}_{r\_rx} ( t ) \vert > \vert {c}_{0} \vert : & {T}_{r\_rx} ( t )\end{matrix} \qquad ( 69 )$$

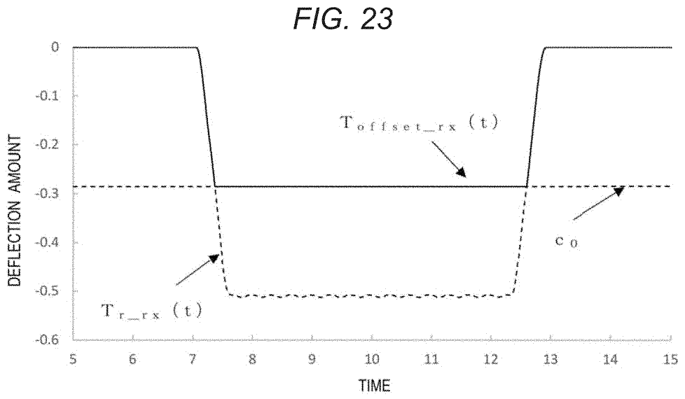

FIG. 23 shows the derived T_{offset_rx} (t). In a graph of FIG. 23, a horizontal axis represents time, and a vertical axis represents the deflection amount. A solid line in the graph of FIG. 23 indicates T_{offset_rx}(t). A dotted line in the graph indicates T_{r_rx}(t). FIG. 23 shows a state in which the value of T_{offset_rx}(t) approaches c₀ with the passage of time from the entry of the railway train into the bridge, remains constant at c₀ for a certain period of time, and converges to 0 with the passage of time when the railway train exits.

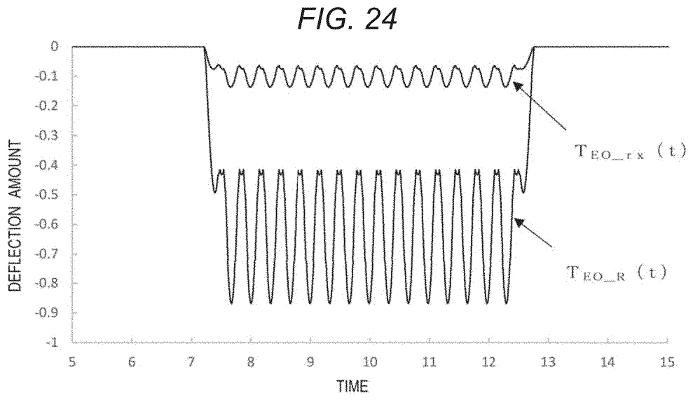

Then, the inventors derived an estimated value T_{Eo_rx}(t) of the deflection amount at the designated position on the bridge by adding T_{offset_rx}(t) to the product of the coefficient c₁ and T_{std_rx}(t) using the following Equation (70). FIG. 24 shows the derived value T_{Eo_rx}(t) and an estimated value T_{E_OR}(t) of the deflection amount at the observation point derived by Equation (61). In a graph of FIG. 24, a horizontal axis represents time, and a vertical axis represents the deflection amount.

T_{EO_rx}=C₁T_{std_rx}(t)T_{offset_rx}(t) (70)

The derivation system 10 of the present embodiment derives the deflection amount of the unit bridge girder at the designated position 9 based on the method conceived by the inventors.

### (2-1-3) Details of Elements

The measurement device 1 and the sensor device 2 of the present embodiment are the same as those of the first embodiment. The server device 3 of the present embodiment is the same as that of the first embodiment except for the function of the deflection derivation unit 306. Hereinafter, the deflection derivation unit 306 of the present embodiment will be described in detail.

Similarly to the first embodiment, the deflection derivation unit 306 has the function of deriving the estimated value of the deflection amount of the unit bridge girder at the designated position 9 based on the time-series data u(t), the first index value T_{std_R}(t), and the second index value T_{std_rx} (t).

With the function of the deflection derivation unit 306, the control unit 300 obtains T_{std_rx_1p}(t)_{f} which is the second index value subjected to the low-pass filter processing, by subjecting the second index value T_{std_rx}(t) to the low-pass filter processing for attenuating a component of a frequency equal to or higher than the fundamental frequency.

Specifically, the control unit 300 executes the FFT on T_{std_rx} (t), and specifies a peak corresponding to a minimum frequency obtained by excluding a peak of a side lobe generated due to an influence of a window function used in the FFT from a result of the FFT. Then, the control unit 300 sets the frequency corresponding to the specified peak as the fundamental frequency F_{f}, and derives the interval k_{mf} using Equation (36). Based on the derived k_{mf}, the control unit 300 replaces T_{std} (t) with T_{std_rx} (t)_{f} replaces T_{std_1p}(t) with T_{std_rx_1p} (t), and derives T_{std_rx_1p} (t) using Equation (37). However, the control unit 300 may obtain T_{std_rx_1p} (t) by applying, to T_{std_rx}(t), another FIR filter that attenuates a component of a frequency equal to or higher than the fundamental frequency.

In addition, the control unit 300 obtains T_{std_R_1p}(t) by subjecting T_{std_R}(t) to the low-pass filter processing for attenuating a component of a frequency equal to or higher than the fundamental frequency. Specifically, the control unit 300 executes the FFT on T_{std_R}(t), and specifies a peak corresponding to a minimum frequency obtained by excluding a peak of a side lobe generated due to an influence of a window function used in the FFT from a result of the FFT. Then, the control unit 300 sets the frequency corresponding to the specified peak as the fundamental frequency F_{f}, and derives the interval k_{mf} using Equation (36). Based on the derived k_{mf}, the control unit 300 replaces T_{std}(t) with T_{std_R}(t), replaces T_{std_1p}(t) with T_{std _R_1p} (t) and derives T_{std_R_1p}(t) using Equation (37). However, the control unit 300 may obtain T_{std _R_1p} (t) by applying, to T_{std_R}(t) another FIR filter that attenuates a component of a frequency equal to or higher than the fundamental frequency.

The control unit 300 derives the amplitude hᵣₓ, which is an average value of T_{std_rx_1p} (t) during the period from t₁ to t₂, using Equation (62). t₁ and t₂ are respectively the start time point and the end time point of the period having a predetermined width (for example, 1 second, 2 seconds, or the like) in the center of the passing period to (the period from the entry time point tᵢ to the exit time point tₒ), but may be those of another period.

The control unit 300 derives the coefficients c₁ and c₀ using Equation (55) and Equation (56) based on u₁ₚ (t) T_{std _R_1p} (t) to (t₁), and t_{b} (to) That is, the control unit 300 derives the coefficients c₁ and c₀ of the linear function that returns u₁ₚ, (t) using T_{std_R_1p}(t) represented by Equation (54) as an argument. T_{std_R_1p}(t) is an example of an amount corresponding to the first index value T_{std_R}(t). u₁ₚ(t) is an example of an amount corresponding to the time-series data u (t). Based on c₁, c₀, and hᵣₓ, the control unit 300 derives a function R_{r_rx}(t) of the amplitude ratio of T_{Estd_rx_1p}(t), which is a value obtained by substituting T_{std_rx_1p}(t) instead of T_{std_R_1p}(t) as an argument into the linear function shown in Equation (53), to T_{std_rx_1p}(t), using Equation (63). That is, the control unit 300 derives the function R_{r_rx}(t) of the amplitude ratio between the deflection amount T_{Estd_rx_1p}(t) restored by adding c₀ to the product of T_{std_rx_1p}(t) and the coefficient c₁ and T_{std_rx_1p}(t). Then, based on t₁, t₂, and T_{std_rx_1p} (t), the control unit 300 derives the average amplitude ratio R_{r_rx} of R_{r_rx}(t) during the period from t₁ to t₂ using Equation (64). R_{r_rx} derived using Equation (64) is an average value of the amplitude ratio during a period during which the value of the amplitude ratio of a value, which is obtained by substituting T_{std_rx_1p}(t) that is the second index value subjected to the low-pass filter processing, as an argument of a linear function of the linear coefficient c₁ and the zero-order coefficient c₀, to T_{std_rx_1p}(t) falls within a range of a predetermined width.

However, the control unit 300 may derive the amplitude ratio R_{r_rx} using Equation (65) based on c₁, c₀, and hᵣₓ. R_{r_rx} derived using Equation (65) is the average amplitude during a period during which the value of T_{std_rx_1p} (t), which is the second index value subjected to the low-pass filter processing, falls within a predetermined width range.

The control unit 300 derives the deflection amount Tr_rx obtained by multiplying T_{std_rx_1p}(t) by R_{r_rx} using Equation (66). However, the control unit 300 may derive the deflection amount T_{r_rx} using Equation (67) based on T_{std_rx_1p}(t) c₁, and c₀. In addition, the control unit 300 may obtain T_{r_rx} as in Equation (68) by setting c₀=0 before the entry time point tᵢ and after the exit time point tₒ.

Then, based on the derived T_{r_rx} the control unit 300 derives the offset T_{offset_rx}(t) of the deflection amount at the designated position 9 using Equation (69). That is, the control unit 300 derives T_{r_rx} obtained by rounding an element whose absolute value is larger than c₀ to c₀ as the offset T_{offset_rx}(t). The control unit 300 derives, using Equation (70), the estimated value T_{Eo_rx}(t) of the deflection amount at the designated position on the bridge by adding the offset T_{offset_rx}(t) to the product of the coefficient c₁ and T_{std_rx}(t).

As described above, according to the configuration of the present embodiment, the derivation system 10 can derive the deflection amount of the unit bridge girder at the designated position 9 different from the observation point.

### (2-2) Derivation Processing

Processing of the derivation system 10 of the present embodiment is the same as that of the first embodiment except for the processing of S125 in the processing in FIG. 19 in the first embodiment. In the processing of the present embodiment, differences from the first embodiment will be described.

In S125, with the function of the deflection derivation unit 306, the control unit 300 obtains T_{std_rx_1p}(t) by subjecting T_{std_rx}(t) to the low-pass filter processing for attenuating a component of a frequency equal to or higher than the fundamental frequency. In addition, the control unit 300 obtains T_{std_rx}(t) by subjecting T_{std}_R(t) to the low-pass filter processing for attenuating a component of a frequency equal to or higher than the fundamental frequency.

The control unit 300 derives the amplitude hᵣₓ of T_{std_rx_1p}(t) using Equation (62). The control unit 300 derives the coefficients c₁ and c₀ using Equation (55) and Equation (56) based on u₁ₚ(t), T_{std_R_1p}(t), tₐ(t₁), and t_{b}(t₀). The control unit 300 derives the function R_{r_rx}(t) of the amplitude ratio using Equation (63) based on T_{Estd_rx_1p}(t) that is, C₁T_{std_rx_1p}(t)+C₀ and T_{std_rx_1p}(t). Then, the control unit 300 derives R_{r_rx} using Equation (64).

The control unit 300 derives the deflection amount T_{r_rx} obtained by multiplying T_{std_rx_1p}(t) by R_{r_rx} using Equation (66). Based on the derived T_{r_rx}, the control unit 300 derives the offset T_{offset_rx}(t) of the deflection amount at the designated position 9 using Equation (69). Then, the control unit 300 derives, using Equation (70), the estimated value T_{Eo_rx}(t) of the deflection amount at a designated position on the bridge by adding T_{offset_rx}(t) to the product of the coefficient c₁ and T_{std_rx}(t).

### (3) OTHER EMBODIMENTS

The above embodiments are examples for carrying out the present disclosure, and various other embodiments can be adopted. The method of deriving the deflection amount of the designated position from the displacement at the observation point as in the above embodiments can also be implemented as an invention of a program or an invention of a method.

Further, a configuration in which the function of the server device 3 is implemented by a plurality of devices may be adopted. The functions of the server device 3 may be distributed and implemented in a plurality of devices. In addition, the functions of the server device 3 may be implemented in another device. For example, the functions of the acquisition unit 301, the environment information acquisition unit 302, the time point derivation unit 303, the number acquisition unit 304, the index value acquisition unit 305, and the deflection derivation unit 306 may be implemented in the measurement device 1. The server device 3 may be distributed in a plurality of devices, or the like. Further, the above embodiments are examples, and an embodiment in which a part of the configuration is omitted or another configuration is added may be adopted.

In the above first and second embodiments, the derivation system 10 derives the deflection amount of the bridge through which the railway train 6 formed with one or more railway vehicles passes. However, the derivation system 10 may derive the deflection amount of the bridge in which the other formation moving object moves. For example, the derivation system 10 may derive a deflection amount of a bridge through which a formation truck in which one or more trucks are coupled, a trailer in which a plurality of vehicles are coupled, or the like passes. In addition, the derivation system 10 may derive a deflection amount of a structure different from a bridge such as a base that supports a railroad track.

In the above first and second embodiments, the number of the sensor devices 2 included in the derivation system 10 is two, but may be one or three or more.

In the above first and second embodiments, the control unit 300 acquires, as the time-series data u(t), the displacement (deflection) data measured from the acceleration detected via the acceleration sensor 210. However, the control unit 300 may acquire, as u(t), displacement data of the bridge derived from a physical quantity detected via a sensor such as an impact sensor, a pressure-sensitive sensor, a strain gauge, an image measuring device, a load cell, or a displacement gauge. For example, the control unit 300 may detect the displacement of the observation point and acquire the detected displacement data by the image measuring device capturing an image of a predetermined object in a cycle, the predetermined object being disposed at the observation point of the bridge 5. The control unit 300 may acquire data of a physical quantity different from the displacement of the bridge as u(t). For example, the control unit 300 may acquire, as u(t), the number of pixels indicating the displacement amount of the predetermined object disposed at the observation point of the bridge 5 in the image captured via the image measuring device.

Further, in the above first and second embodiments, the control unit 300 specifies the peak corresponding to the lowest frequency, except for the side lobe generated due to the influence of the window function used in the FFT, from the result of the FFT on the time-series data u(t) acquired by the function of the acquisition unit 301, and obtains the specified peak as the fundamental frequency F_{f}. However, in consideration of an influence of a noise generated in the result of the FFT on u(t), the control unit 300 may obtain the fundamental frequency F_{f}. For example, the control unit 300 may specify a peak equal to or greater than a predetermined threshold corresponding to the lowest frequency, except for the side lobe generated due to the influence of the window function used in the FFT, from the result of the FFT on u(t), and obtain the specified peak as the fundamental frequency F_{f}.

In the above first embodiment, the control unit 300 derives a value obtained by multiplying the average value Ravg of the ratio of the first index value T_{std}_R(t) to the second index value T_{std_rx}(t) by the time-series data u(t) as the estimated value of the deflection amount at the designated position 9. However, the control unit 300 may derive the estimated value of the deflection amount at the designated position 9 by another method.

For example, the control unit 300 may derive a value obtained by multiplying the first index value T_{std}_R(t) by Ravg as the estimated value of the deflection amount at the designated position 9.

In addition, the control unit 300 may derive the estimated value of the deflection amount at the designated position 9 as follows. Similarly to the second embodiment, the control unit 300 derives T_{std_R_1p}(t) and coefficients c₁ and c₀. Then, the control unit 300 derives T_{std_R_1p}(t) using Equation (58) based on T_{std_R_1p}(t), c₁, and c₀.

The control unit 300 extracts data of the deflection amount during a period of a predetermined length (for example, 1 second, 2 seconds, or the like) from u₁ₚ(t), and determines the extracted period as the period during which the deflection amount is shifted during which the absolute value of the average value of the extracted data is equal to or greater than a predetermined threshold and the absolute value of the difference between the maximum value and the minimum value of the extracted data is equal to or less than the predetermined width. In addition, the control unit 300 may receive the designation of the start time point and the end time point of the period when the deflection amount is shifted via an operation unit or the like of the server device 3. Then, the control unit 300 sets the order of the earliest observation of the deflection amount during the period during which the deflection amount is shifted as k₀. In addition, the control unit 300 sets a value obtained by subtracting k₀ from the order of the latest observation of the deflection amount during the period during which the deflection amount is shifted as N. Then, the control unit 300 derives the amplitude ratio Rᵣ using Equation (59) based on k₀, N, T_{std_R_1p}(t), and T_{Estd_R_1p} (t).

The control unit 300 derives the offset T_{offset_R_std}(t) at the observation point using Equation (60) based on the amplitude ratio Rᵣ and T_{std_R_1p}(t). Based on c₁, T_{std}_R(t), and T_{offset_R_std}(t), the control unit 300 derives the estimated value T_{EO_R}(t) of the deflection amount at the observation point using Equation (61). Then, the control unit 300 may derive a value obtained by multiplying T_{E_OR}(t) by Ravg as the estimated value of the deflection amount at the designated position 9.

The time-series data may be data acquired at a data rate of twice or more the frequency of vibration assumed to occur in the structure due to the movement of the formation moving object.

Further, the present disclosure can also be applied as a program executed by a computer or a method. In addition, the program and method as described above may be implemented as a single device or may be implemented by using components included in a plurality of devices, and includes various aspects. In addition, it is possible to appropriately change the configuration such that a part of the configuration is software and a part of the configuration is hardware. Further, the present disclosure is also applicable to a recording medium of a program. As a matter of course, the recording medium of the program may be a magnetic recording medium, a semiconductor memory, or the like, and any recording medium to be developed in the future can be considered in the same manner.

What is claimed is:

1. A derivation method, comprising:
an acquisition step of acquiring time-series data including a physical quantity generated at a predetermined observation point in a structure as a response caused by a movement of a formation moving object formed with one or more moving objects on the structure;
an environment information acquisition step of acquiring, as environment information, information on a structure length that is a length of the structure, a moving object length that is a length of the moving object, and an installation position of a contact portion of the moving object with the structure;
a time point derivation step of deriving an entry time point and an exit time point of the formation moving object with respect to the structure, based on the time-series data;
a number acquisition step of acquiring the number of the moving objects formed in the formation moving object;
an index value acquisition step of acquiring, based on the number, the entry time point, the exit time point, and the environment information, a first index value that is an index value of a deflection amount of the structure generated at the observation point, and a second index value that is an index value of a deflection amount at a designated position in the structure; and
a deflection derivation step of deriving an estimated value of the deflection amount of the structure at the position based on the time-series data, the first index value, and the second index value.

2. The derivation method according to claim 1, wherein
in the time point derivation step, the entry time point and the exit time point are derived by performing, for each of the entry time point and the exit time point, processing of acquiring a time point within a period after one time point and before another time point among two time points corresponding to two consecutive pieces of data between which a predetermined threshold is, the two consecutive pieces of data being included in the time-series data on which low-pass filter processing of attenuating a vibration component of a frequency equal to or higher than a fundamental frequency of the time-series data is performed.

3. The derivation method according to claim 1, wherein
in the deflection derivation step,
the estimated value is derived, from the entry time point to the exit time point, based on a linear coefficient and a zero-order coefficient of a linear function in which approximation of an amount corresponding to the time-series data is obtained when an amount corresponding to the first index value is substituted into an argument and the second index value,
the amount corresponding to the time-series data is an amount after the component of the frequency equal to or higher than the fundamental frequency of the time-series data is attenuated from the time-series data, and
the amount corresponding to the first index value is an amount obtained by attenuating a component of a frequency equal to or higher than a fundamental frequency of the first index value from the first index value.

4. The derivation method according to claim 3, wherein
in the deflection derivation step, a sum of an offset that is a portion of the estimated value that is not proportional to the second index value, and a product of the linear coefficient of the linear function and the second index value is derived as the estimated value, the offset being derived based on the second index value and the coefficient of the linear function.

5. The derivation method according to claim 4, wherein
the offset is a product of the second index value and an average value of an amplitude ratio during a period, during which a value of the amplitude ratio of a value obtained by substituting, as an argument of the linear function, the second index value subjected to the low-pass filter processing for attenuating a component of a frequency equal to or higher than a fundamental frequency of the second index value and the second index value subjected to the low-pass filter processing falls within a range of a predetermined width, and is a value obtained by rounding an element having an absolute value larger than the zero-order coefficient of the linear function to a value of the zero-order coefficient of the linear function.

6. The derivation method according to claim 4, wherein
the offset is a product of the second index value and an amplitude ratio of a value obtained by substituting, as an argument of the linear function, an average amplitude of the second index value during a period, during which a value of the second index value subjected to the low-pass filter processing for attenuating a component of a frequency equal to or higher than a fundamental frequency of the second index value falls within a range of a predetermined width, to the amplitude, and is a value obtained by rounding an element having an absolute value larger than the zero-order coefficient of the linear function to a value of the zero-order coefficient of the linear function.

7. The derivation method according to claim 1, wherein
in the deflection derivation step, the estimated value is derived based on the time-series data and an average value of a ratio of a predetermined amount corresponding to the first index value to a predetermined amount corresponding to the second index value during a period from the entry time point to the exit time point.

8. The derivation method according to claim 1, wherein
in the number acquisition step, a value obtained by subtracting one from a product of a period from the entry time point to the exit time point and a fundamental frequency of the time-series data and rounding to an integer is acquired as the number.

9. The derivation method according to claim 1, wherein the structure is a bridge.

10. The derivation method according to claim 1, wherein
the moving object is a railway vehicle that moves on the structure via a wheel.

11. The derivation method according to claim 1, wherein
the time-series data is data based on data detected via at least one of an acceleration sensor, an impact sensor, a pressure-sensitive sensor, a strain gauge, an image measuring device, a load cell, and a displacement gauge.

12. The derivation method according to claim 1, wherein
Bridge Weigh in Motion (BWIM) is applicable to the structure.

13. A derivation device, comprising:
an acquisition unit configured to acquire time-series data including a physical quantity generated at a predetermined observation point in a structure as a response caused by a movement of a formation moving object formed with one or more moving objects on the structure;
an environment information acquisition unit configured to acquire, as environment information, information on a structure length that is a length of the structure, a moving object length that is a length of the moving object, and an installation position of a contact portion of the moving object with the structure;
a time point derivation unit configured to derive an entry time point and an exit time point of the formation moving object with respect to the structure based on the time-series data;
a number acquisition unit configured to acquire the number of the moving objects formed in the formation moving object;
an index value acquisition unit configured to acquire, based on the number, the entry time point, the exit time point, and the environment information, a first index value that is an index value of a deflection amount of the structure generated at the observation point, and a second index value that is an index value of a deflection amount at a designated position in the structure; and
a deflection derivation unit configured to derive an estimated value of the deflection amount of the structure at the position based on the time-series data, the first index value, and the second index value.

14. A derivation system comprising: a derivation device; and a sensor, wherein
the derivation device includes:
an acquisition unit configured to acquire time-series data including a physical quantity that is generated at a predetermined observation point in a structure as a response caused by a movement of a formation moving object formed with one or more moving objects on the structure and that is measured via the sensor;
an environment information acquisition unit configured to acquire, as environment information, information on a structure length that is a length of the structure, a moving object length that is a length of the moving object, and an installation position of a contact portion of the moving object with the structure;
a time point derivation unit configured to derive an entry time point and an exit time point of the formation moving object with respect to the structure based on the time-series data;
a number acquisition unit configured to acquire the number of the moving objects formed in the formation moving object;
an index value acquisition unit configured to acquire, based on the number, the entry time point, the exit time point, and the environment information, a first index value that is an index value of a deflection amount of the structure generated at the observation point, and a second index value that is an index value of a deflection amount at a designated position in the structure; and
a deflection derivation unit configured to derive an estimated value of the deflection amount of the structure at the position based on the time-series data, the first index value, and the second index value.

15. A non-transitory computer-readable storage medium storing a program, the program for causing a computer to execute:
an acquisition step of acquiring time-series data including a physical quantity generated at a predetermined observation point in a structure as a response caused by a movement of a formation moving object formed with one or more moving objects on the structure;
an environment information acquisition step of acquiring, as environment information, information on a structure length that is a length of the structure, a moving object length that is a length of the moving object, and an installation position of a contact portion of the moving object with the structure;
a time point derivation step of deriving an entry time point and an exit time point of the formation moving object with respect to the structure based on the time-series data;
a number acquisition step of acquiring the number of the moving objects formed in the formation moving object;
an index value acquisition step of acquiring, based on the number, the entry time point, the exit time point, and the environment information, a first index value that is an index value of a deflection amount of the structure generated at the observation point, and a second index value that is an index value of a deflection amount at a designated position in the structure; and
a deflection derivation step of deriving an estimated value of the deflection amount of the structure at the position based on the time-series data, the first index value, and the second index value.
